(19) United States
(12) Patent Application Publication
(10) Pub. No.: US 2007/0270187 A1
(43) Pub. Date: Nov. 22, 2007

(54) Information processing device

(75) Inventor: Takushiro Haneda, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/731,848

(22) Filed: Mar. 30, 2007

(30) Foreign Application Priority Data
May 18, 2006 (JP) P2006-138970

(51) Int. Cl. H04M 1/00

(52) U.S. Cl. 455/566

(57) ABSTRACT

In a camera-equipped digital mobile phone that can be applied as the information processing device, a storage unit stores a main menu and a plurality of sub menu information related to the main menu information while being associated with category identification information indicating a category of the main menu information, a display control unit displays the main menu information and the plurality of sub menu information stored while being associated with the category identification information for each category identification information on a liquid crystal display, a category identification information selection accepting unit accepts a selection of one of plurality of the category identification information, a sub menu selection accepting unit accepts a selection of one of the plurality of the sub menu information, and a function execution control unit controls execution of a function related to the sub menu whose selection is accepted.

### BACKGROUND OF THE INVENTION

1. Field of the Invention

The present invention relates to an information processing device, and more particularly, to an information processing device to which a plurality of functions are installed.

2. Related Art

In recent years, various application programs have been previously written in and installed or mounted to information processing devices such as a mobile phone and a PDA (Personal Digital Assistant). Further, the various application programs can be added and mounted to these information processing devices through a user's preference by arbitrarily executing a download from an application program download server via a network.

Incidentally, for the conventional mobile phone, PDA, and the like, such a method is proposed that a telephone directory to be used at a time of communication is displayed in the form of tabs, and the tabs are displayed in the order of other user names and sorted in accordance with groups. In addition, a method is also proposed in which at a time of tab display, it is possible to shift a focus on the respective displayed tabs by pressing a numeral key for a short period of time among operation keys.

Furthermore, such a method is also proposed that various functions including an application program that has been registered in a short cut function are displayed in the form of icons, in a list, or the like, and the displayed various functions can be utilized with use of a function key or the like.

For example, according to a conventional mobile phones, when a desired function is activated among a plurality of registered functions, there is such a fear that an operability is poor as the user not only needs to reliably perform the key operation without errors and but also may need to perform a plurality of key operations in some cases.

### SUMMARY OF THE INVENTION

Accordingly, the present invention has been made in view of the above circumstances and it is an object of the present invention to provide an information processing device that can enhance an operability in a case where a plurality of functions that are mounted to the information processing device are utilized.

In order to achieve the above object, an information processing device according to one aspect of the present invention includes: a memory unit configured to store a main menu information and a plurality of sub menu information related to the main menu information while being associated with category identification information indicating a category of the main menu information; a display unit configured to display the main menu information and the plurality of the sub menu information which are stored while being associated with the category identification information by the memory unit, for each category identification information; a category identification information reception unit configured to accept a selection of one of the category identification information among plural pieces of the category identification information; a sub menu reception unit configured to accept a selection of one of the sub menu among the plurality of the sub menu information associated with the category identification information whose selection is accepted; and a control unit configured to control an execution of a function related to the sub menu whose selection is accepted by the sub menu reception unit.

In addition, in order to achieve the above-mentioned object, an information processing device according to another aspect of the present invention includes: a memory unit configured to store category identification information while being associated with a plurality of sub menu information related to the category identification information; a display unit configured to display plural pieces of the category identification information in a predetermined direction and displaying a plurality of the sub menu information stored while being associated with one category identification information among the plural pieces of the category identification information in a same direction as the predetermined direction; a category identification information reception unit configured to accept a selection of one category identification information among the plural pieces of the category identification information; a sub menu reception unit configured to accept a selection of one sub menu among the plurality of sub menu information while being associated with one category identification information whose selection is accepted by the category identification information reception unit; and a control unit configured to control an execution of a function related to the sub menu whose selection is accepted by the sub menu reception unit.

According to the present invention of the structures mentioned above, in a case where a plurality of functions that are mounted to the information processing device are utilized, the operability can be improved.

The nature and further characteristic features of the present invention will be made clearer from the following descriptions made with reference to the accompanying drawings.

### BRIEF DESCRIPTION OF THE DRAWINGS

In the accompanying drawings:

FIGS. 1A and 1B respectively show an external appearance of a camera-equipped digital mobile phone that can be applied as an information processing device when opened at about 180 degrees as viewed from the front and the side according to the present invention;

FIGS. 2A and 2B respectively show an external appearance of the camera-equipped digital mobile phone that can be applied as the information processing device when closed as viewed from the front and the side according to the present invention;

FIG. 3 is a block diagram showing an internal configuration of the camera-equipped digital mobile phone that can be applied as the information processing device according to the present invention;

FIG. 4 is a block diagram showing a functional configuration for realizing the camera-equipped digital mobile phone that can be applied as the information processing device according to the present invention;

FIG. 5 shows a hierarchy structure of a main menu, a sub menu, and category identification information which are stored in a memory unit of FIG. 4 while being associated with one another;

FIG. 6 shows a configuration of a sub menu management file of FIG. 5;

FIG. 7 shows a configuration of a sub menu management file of a first lower hierarchy rank sub menu management file of FIG. 5;

FIG. 8 is a flowchart for describing a sub menu registration process in the camera-equipped digital mobile phone of FIG. 4;

FIG. 9 shows a display example of a new sub menu selection dialog displayed on a liquid crystal display of FIG. 3;

FIG. 10 shows a configuration example of a prescribed sub menu management table stored in the memory unit of FIG. 4;

FIG. 11 shows a display example of a registration candidate category identification information selection dialog displayed on the liquid crystal display of FIG. 3;

FIG. 12 is a flowchart for describing a category identification information display control process in the camera-equipped digital mobile phone of FIG. 4;

FIG. 13 shows a display example of a category identification information display screen displayed on the liquid crystal display of FIG. 3;

FIG. 14 shows a display example of the category identification information display screen displayed on the liquid crystal display of FIG. 3;

FIG. 15 shows a display example of the category identification information display screen displayed on the liquid crystal display of FIG. 3;

FIG. 16 shows a display example of the category identification information display screen displayed on the liquid crystal display of FIG. 3;

FIG. 17 shows a display example of an input assistance screen for a simplified calculator displayed on the liquid crystal display of FIG. 3;

FIG. 18 shows a display example of the category identification information display screen displayed on the liquid crystal display of FIG. 3;

FIG. 19 shows a display example of a lower hierarchy rank sub menu display screen displayed on the liquid crystal display of FIG. 3;

FIG. 20 shows a display example of a ring volume setting screen displayed on the liquid crystal display of FIG. 3; and

FIG. 21 is a flowchart for describing another category identification information display control process in the camera-equipped digital mobile phone of FIG. 4.

### DESCRIPTION OF THE PREFERRED EMBODIMENTS

Hereinafter, embodiment of the present invention will be described with reference to the accompanying drawings.

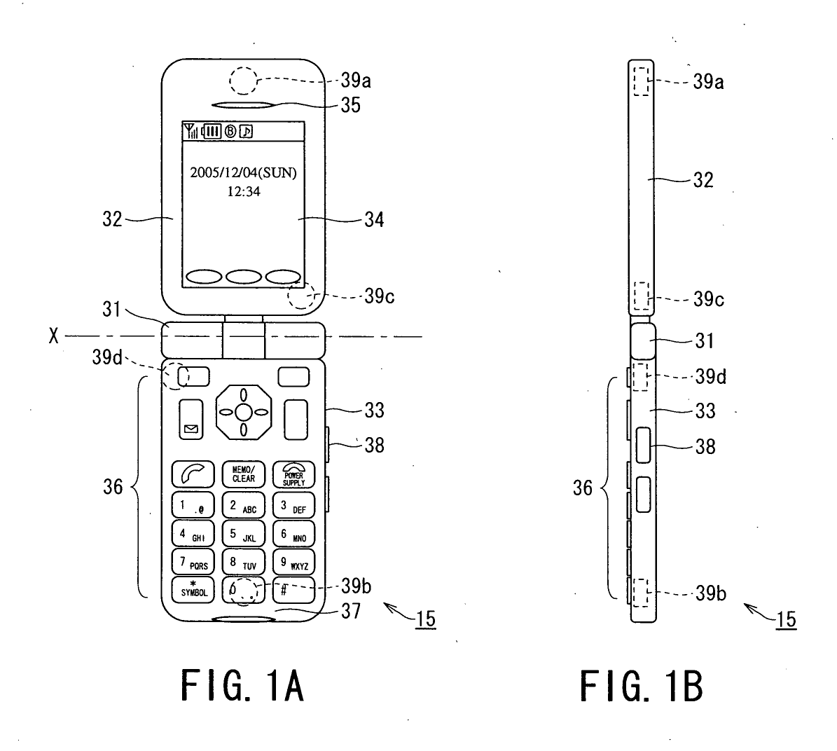

FIGS. 1A and 1B show an external appearance of a camera-equipped digital mobile phone 15 that can be applied as an information processing device according to the present invention. It should be noted that FIG. 1A shows an external appearance of the camera-equipped digital mobile phone 15 when opened at about 180 degrees as viewed from the front, and FIG. 1B shows an external appearance of the camera-equipped digital mobile phone 15 when opened as viewed from the side.

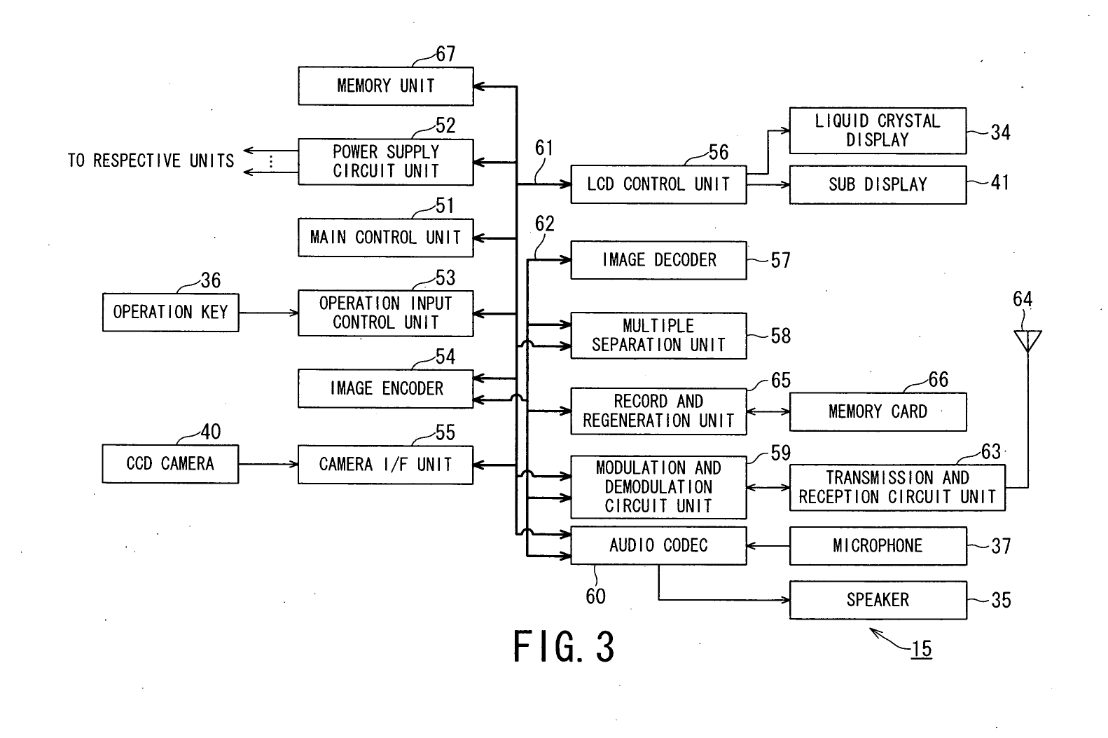

As shown in FIGS. 1A and B, in the camera-equipped digital mobile phone 15, a first enclosure 32 and a second enclosure 33 are connected to each other with use of a hinge with a hinge or hinge member 31 located at a center and are formed so as be folded with use of the hinge member 31. An antenna for transmission and reception (an antenna 64 of FIG. 3 as will be described later) is provided at a predetermined position inside the camera-equipped digital mobile phone 15, an electric wave is transmitted and received with respect to a base station (not shown in the drawing) via the antenna.

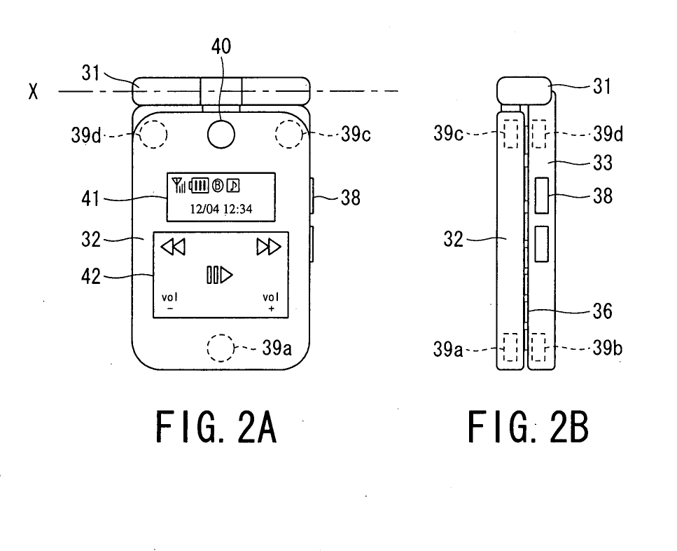

The first enclosure 32 is provided with a liquid crystal display 34 on its front side, by which there can be displayed an electric wave reception status, a battery remaining amount, a name and a telephone number of an other party registered in a telephone directory, and a transmission history as well as a content of an electronic mail, a simplified home page, an image picked up with use of a CCD (Charge Coupled Device) camera (a CCD camera 40 of FIGS. 2A and 2B as will be described later), a content received from an external content server (not shown in the drawing), and a content stored in the memory card (a memory card 66 of FIG. 3 as will be described later).

In addition, a speaker 35 is also provided at a predetermined position of an upper part of the liquid crystal display 34, and with this configuration, the user can perform verbal communication.

On the other hand, the second enclosure 33 is provided with on its surface, operation keys 36 such as numeral keys “0” to “9”, a call request key, a redial key, a call end and power supply key, a clear key, and an electronic mail key. With use of the operation keys 36, it is possible to input various instructions.

The second enclosure 33 is provided with an arrow key and an enter key as the operation keys 36 at its upper area, and the user operates the arrow key in up, down, left, and right directions, whereby the corresponding cursor can be moved in the up, down, left, and right directions. To be more specific, various operations such as a scroll operation on a telephone directory list or an electronic mail displayed on the liquid crystal display 34, a page roll operation the simplified home page, and an image feed operation are executed.

In addition, by pressing down the enter key, various functions can be confirmed. For example, in the second enclosure 33, in accordance with the operation of the arrow key by the user, a desired telephone number is selected among a plurality of telephone numbers in the telephone directory list displayed on the liquid crystal display 34. Then, the enter key is pressed in the internal direction of the second enclosure 33, and the selected telephone number is confirmed, whereby a call request process is performed with respect to the telephone number.

Furthermore, the second enclosure 33 is provided with the electronic mail key next to the arrow key and the enter key on the left hand side. When the electronic mail key is pressed in the internal direction of the second enclosure 33, it is possible to call up a mail transmitting and receiving function.

A browser key is provided on the right-hand side of the arrow key and the enter key. When the browser key is pressed in the internal direction of the second enclosure 33, the data of the Web page can be browsed.

In addition, the second enclosure 33 is also provided with a microphone 37 at a lower area of the operation keys 36, and through the microphone 37, a voice of the user at the time of call can be collected. Moreover, the second enclosure 33 is provided with a side key 38 for performing an operation of the camera-equipped digital mobile phone.

It should be noted that a battery pack not shown in the drawing is inserted to be mounted on the back side of the second enclosure 33. When a call end and power supply key is turned ON, an electric power is supplied to the respective circuit units from the battery pack and the circuit units are activated in the operating state.

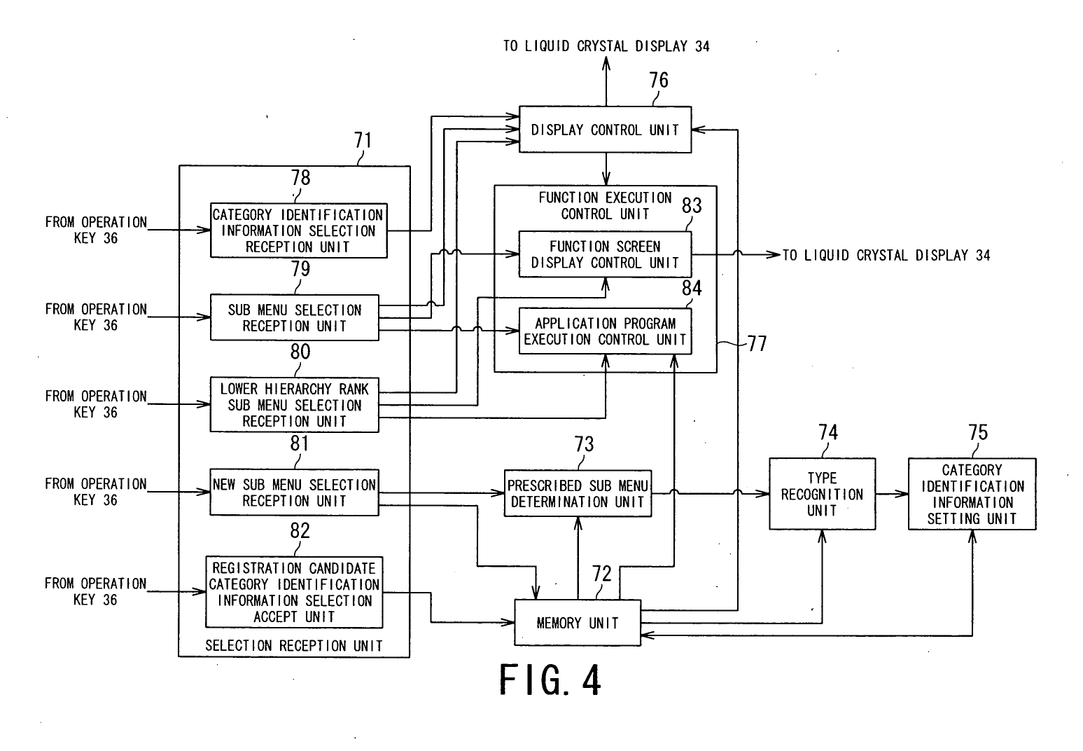

Incidentally, the second enclosure 33 is provided with a memory card slot (not shown in the drawing) for mounting the memory card (the memory card 66 of FIG. 4 as will be described later) to a predetermined position at a lower part of the second enclosure 33 so as to be also removed therefrom. When a memo button (not shown in the drawing) is pressed down, it is possible to record the voice of the other party during the conversation in the memory card and also record the electronic mail, the simplified home page, and the images picked up by a CCD camera in response to the operations of the user.

Herein, the memory card is one type of flash memory cards. The memory card is configured to accommodate in a small and thin plastic case a flash memory element which is one type of a non-volatile memory capable of electrically rewriting and deleting data. With the use of the memory card, it becomes possible to write and read various data of such as an image, a voice, and music via a 10 pin terminal.

In addition, the memory card adopts a unique serial protocol with which compatibility among used devices can be ensured even when a specification of a built-in flash memory is changed for a larger volume or the like. At the same time, the memory card realizes a high speed performance and ensures a high reliability with the provision of an error deletion preventing switch.

Therefore, with the above-described structure, such a memory card can be inserted to the camera-equipped digital mobile phone 15 and it is possible to achieve data communization with other electronic devices via the memory card.

Furthermore, at predetermined positions inside the first enclosure 32 and the second enclosure 33, magnetic sensors 39a, 39b, 39c, and 39d for detecting the state of the camera-equipped digital mobile phone 15 are provided. With this configuration, it is possible to detect a current state of the camera-equipped digital mobile phone 15.

FIGS. 2A and 2B show another external appearance of the camera-equipped digital mobile phone 15 that can be applied as the information processing device according to the present invention. It should be noted that FIG. 2A shows an external appearance of the camera-equipped digital mobile phone 15 when closed as viewed from the front side, and FIG. 2B shows an external appearance of the camera-equipped digital mobile phone 15 when closed as viewed from the side.

The CCD camera 40 is provided at an upper portion of the first enclosure 32, and with this configuration, a desired image pickup target can be captured. A sub display 41 is provided at a lower portion of the CCD camera 40, an antenna pictograph showing a current level of the sensitivity of the antenna, a battery pictograph showing a current remaining battery of the camera-equipped digital mobile phone 15, the current time, and the like are displayed thereon.

Furthermore, an electrostatic touch pad 42 is provided at a lower part of the sub display 41. The electrostatic touch pad 42 looks like one sheet of a touch panel, but sensors, not shown in the drawing, are provided at plural locations. When the user touch an area in the vicinity of one of the sensors, the sensor detects the touch, and a rewind function, a fast-forward function, a volume down operation, a volume up operation, a reproduction operation, a pause operation, and the like are executed.

FIG. 3 shows an internal configuration of the camera-equipped digital mobile phone 15 that can be applied as the information processing device according to the present invention.

As shown in FIG. 3, the camera-equipped digital mobile phone 15 has the following configuration. That is, with respect to a main control unit 51 controlling the respective units of the first enclosure 32 and the second enclosure 33 in an overall manner, a power supply circuit unit 52, an operation input control unit 53, an image encoder 54, a camera interface unit 55, an LCD (Liquid Crystal Display) control unit 56, a multiple separation unit 58, a modulation and demodulation circuit unit 59, an audio codec 60, and the memory unit 67 are connected to one another via a main bus 61. In addition, the image encoder 54, an image decoder 57, the multiple separation unit 58, the modulation and demodulation circuit unit 59, the audio codec 60, and a record and regeneration unit 65 are connected to one another via a synchronization bus 62.

In response to the operation of the user, the call end and power supply key is turned ON, the power supply circuit unit 52 supplies the electric power to the respective units from the battery pack, thus activating the camera-equipped digital mobile phone 15 in the operating state.

The main control unit 51 is composed of a CPU (central Processing Unit), a ROM (Read Only Memory), a RAM (Random Access Memory) and the like. The CPU executes various processes in accordance with the programs stored in the ROM or the various application programs loaded from the memory unit 67 to the RAM to generate various control signals.

The control signals are supplied to the respective units to thereby control the camera-equipped digital mobile phone 15 in the overall manner. The RAM appropriately stores necessary data needed by the CPU to execute the various processes or the like.

It should be noted that the main control unit 51 has a built-in timer for measuring the current date and time with precision.

Herein, the various application programs executed by the CPU can be installed in the ROM or the memory unit 67 in advance. In addition, the various application programs executed by the CPU can be installed in the memory unit 67 by downloading the programs to the camera-equipped digital mobile phone 15 through a communication via the base station, not shown in the drawing.

Furthermore, the various application programs executed by the CPU can be installed in the memory unit 67 by recording the program to the memory card 66 and reading out the programs with the use of the record and regeneration unit 65.

On the basis of the control of the main control unit 51, the camera-equipped digital mobile phone 15 converts the audio signal collected at the time of verbal communication by the microphone 37 into a digital audio signal with use of the audio codec 60 for compression, and performs a spread spectrum process on this digital audio signal with use of the modulation and demodulation circuit unit 59.

After the signal is subjected to a digital analog conversion process and a frequency conversion process by a transmission and reception circuit unit 63, the signal is transmitted to the antenna 64.

Further, the camera-equipped digital mobile phone 15 amplifies the reception signal received by the antenna 64 at the time of verbal communication and performs the frequency conversion process and an analog digital conversion process on the signal. Then, the signal is subjected to a spectrum inverse diffusion process by the modulation and demodulation circuit unit 59 and expanded by the audio codec 60. After the signal is converted into an analog audio signal, the converted analog audio signal is outputted via the speaker 35.

Furthermore, in a case where the camera-equipped digital mobile phone 15 sends an electronic mail at the time of a data communication mode, the text data of the electronic mail inputted by way of the operations of the operation key 36 is sent via the operation input control unit 53 to the main control unit 51. The main control unit 51 performs the spread spectrum process on the text data with use of the modulation and demodulation circuit unit 59 and performs the digital analog conversion process and the frequency conversion process through the transmission and reception circuit unit 63.

Thereafter, the signal is sent via the antenna 64 to the base station, not shown in the drawing.

In contrast, when the camera-equipped digital mobile phone 15 receives an electronic mail at the time of the data communication mode, the reception signal received via the antenna 64 from the base station, not shown in the drawing, is subjected to the spectrum inverse diffusion process with the use of the modulation and demodulation circuit unit 59 for decompression into the original text data, and thereafter, the data is displayed on the liquid crystal display 34 as the electronic mail through the LCD control unit 56.

Then, the camera-equipped digital mobile phone 15 can also record the electronic mail received in accordance with the operation of the user via the record and regeneration unit 65 to the memory card 66.

In a case where the camera-equipped digital mobile phone 15 does not transmit the image signal, the signal of the image picked up with the use of the CCD camera 40 is directly displayed on the liquid crystal display 34 via the camera interface unit 55 and the LCD control unit 56.

When the camera-equipped digital mobile phone 15 transmits an image signal at the time of a data communication mode, the image signal picked up with use of the CCD camera 40 is supplied via the camera interface unit 55 to the image encoder 54.

The image encoder 54 converts the image signal supplied from the CCD camera 40 into an encoded image signal through a predetermined encoding method, for example, MPEG (Moving Picture Experts Group) 4 by way of compression coding, and transmits the encoded image signal after the conversion to the multiple separation unit 58. At the same time, the camera-equipped digital mobile phone 15 transmits the audio collected by the microphone 37 during the image pickup with the use of the CCD camera 40, to a multiple separation unit 59 via the audio codec 60 as a digital audio signal.

The multiple separation unit 59 then multiplexes the encoded image signal supplied from the image encoder 54 with the audio signal supplied from the audio codec 60 through a predetermined method, and the multiplexed signal obtained from the multiplying is subjected to the spread spectrum process by the modulation and demodulation circuit unit 59. The signal is subjected to the digital analog conversion process and the frequency conversion process by the transmission and reception circuit unit 63, and thereafter, the signal is sent via the antenna 64.

In contrast, the camera-equipped digital mobile phone 15 can receive the data of the Web page at the time of the data communication mode.

That is, in the camera-equipped digital mobile phone 15, in the data communication mode, for example, when the data requesting the Web page is transmitted, in response to the request, the data of the Web page is transmitted via the base station, not shown in the drawing. This data of the Web page is received via the antenna 64 by the transmission and reception circuit unit 63 and the modulation and demodulation circuit unit 59. Then, the transmission and reception circuit unit 63 and the modulation and demodulation circuit unit 59 send the received Web page data to the main control unit 51.

The main control unit 51 interprets the data of the Web page and generates a screen (image) on the basis of the interpretation. The thus generated screen is supplied from the main control unit 51 via the LCD control unit 56 to the liquid crystal display 34 and displayed thereon. That is, an application program of a Web browser is installed at least on the ROM or the memory unit 67 of the main control unit 51, and the CPU of the main control unit 51 executes the application program of the Web browser on the RAM, whereby a function as the Web browser is achieved to perform the interpretation on the data of the Web page or the like.

In addition, when the camera-equipped digital mobile phone 15 receives the data of the moving image file linked to the Web page or the like at the time of the data communication mode, for example, the reception signal received via the antenna 64 from the base station, not shown in the drawing, is subjected to the spectrum inverse diffusion process by the modulation and demodulation circuit unit 59, and the multiplexed signal obtained as the result is sent to the multiple separation unit 58.

The multiple separation unit 58 separates the multiplexed signal into the encoded image signal and the audio signal. The encoded image signal is supplied, via the synchronization bus 62, to the image decoder 57, and at the same time, the audio signal is supplied to the audio codec 60.

The image decoder 57 decodes the encoded image signal through a decoding method associated with the predetermined encoding method such as MPEG4 to generate a reproduction moving image signal and supplies the thus generated reproduction moving image signal via the LCD control unit 56 to the liquid crystal display 34.

Further, with this configuration, for example, the moving image data included in the moving image file that is linked to the Web page or the like is displayed.

At the same time, the audio codec 60 converts the audio signal into an analog audio signal, and then supplies the converted signal to the speaker 35, and with this configuration, for example, the audio signal included in the moving image file that is linked to the Web page or the like is regenerated. In this case too, similarly to the case of the electronic mail, the camera-equipped digital mobile phone 15 can record the received data that is linked to the Web page or the like to the memory card 66 in response to the operation of the user via the record and regeneration unit 65.

The memory unit 67 is composed, for example, of a flash memory element that is one type of a non-volatile memory capable of electrically rewriting and deleting data and stores various application programs executed by the CPU of the main control unit 51 and a group of various data. In addition, the memory unit 67 stores, when necessary, the electronic mail received in accordance with the operation of the user, the moving image data included in the received moving image file that is linked to the Web page or the like.

FIG. 4 shows a functional configuration capable of executing the camera-equipped digital mobile phone 15 that can be applied as the information processing device according to the present invention.

A selection accept unit 71 is composed of a category identification information selection accept unit 78, a sub menu selection reception unit 79, a lower hierarchy rank sub menu selection reception unit 80, a new sub menu selection reception unit 81, and a registration candidate category identification information selection accept unit 82 and accepts various selections by way of the operations of the operation keys from the user.

The category identification information selection accept unit 78 accepts, in response to the operations of the operation keys 36 by the user, the selection of category identification information indicating a category of the main menu whose activation is desired by the user, and supplies the category identification information whose selection is accepted to a display control unit 76.

It should be noted that the category identification information includes a so-called tab or the like and also may be an icon with which it is possible to identify the category of the main menu.

The sub menu selection reception unit 79 accepts, in response to the operations of the operation keys 36 by the user, the selection of one of the plurality of sub menus related to the main menu and supplies the sub menu whose selection has been accepted to the display control unit 76 and a function execution control unit 77.

The lower hierarchy rank sub menu selection reception unit 80 accepts, in response to the operations of the operation keys 36 by the user, the selection of one of the plurality of low rank sub menus belonging to the lower rank of the sub menu and supplies the low rank sub menu whose selection has been accepted to the display control unit 76 and the function execution control unit 77.

The new sub menu selection reception unit 81 accepts, in response to the operations of the operation keys 36 by the user, the selection of a new sub menu that has not be registered yet and supplies the new sub menu whose selection has been accepted to a memory unit 72 and a prescribed sub menu determination unit 73.

In response to the operations of the operation keys 36 by the user, the registration candidate category identification information selection accept unit 82 accepts selection of the registration candidate category identification information, which is to be registered, in association with a new sub menu that is not a prescribed sub menu (i.e., a sub menu in which category identification information to be associated therewith in a sub menu registration process which will be described later is previously determined), and supplies the registration candidate category identification information whose selection is accepted to the memory unit 72.

The memory unit 72 previously stores a main menu and a plurality of sub menus related to the main menu in association with category identification information that indicates a category of the main menu.

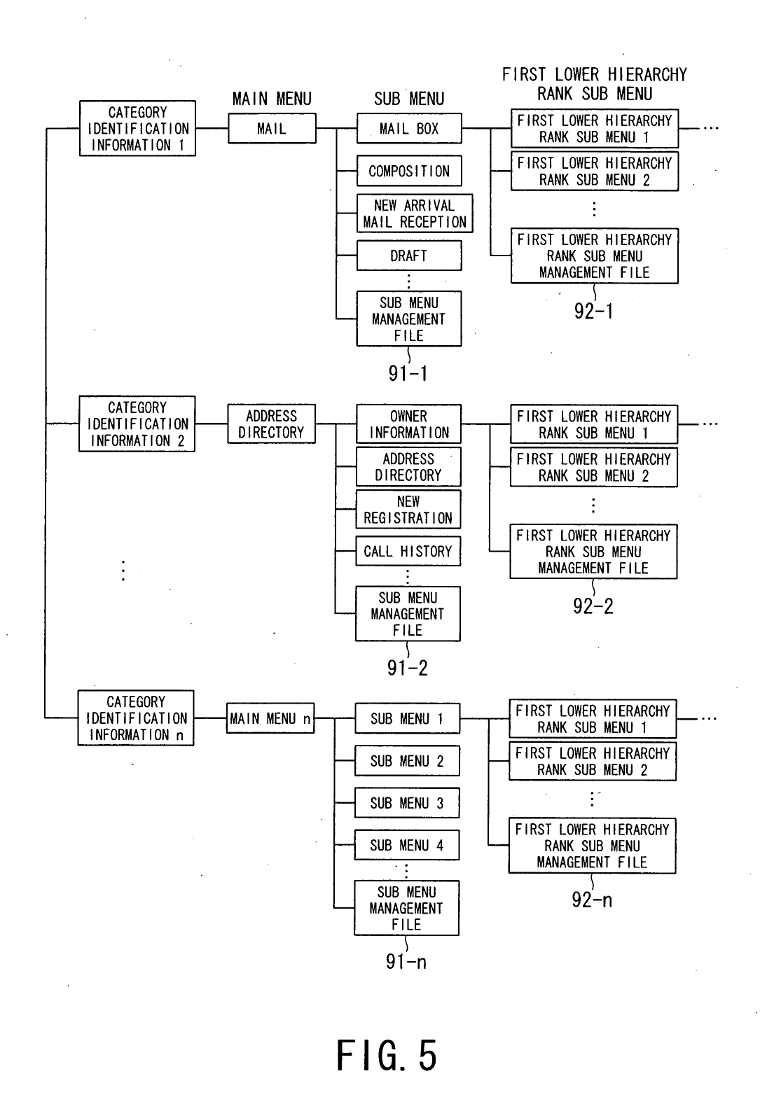

FIG. 5 shows main menus, sub menus, and category identification information which are stored in association with the memory unit 72.

As shown in FIG. 5, there are formed category identification information (category identification information 1 to n) at the top rank hierarchy, main menus (Mail, Address directory, . . . Main menu n) and a plurality of sub menus. In addition, below the sub menus, a hierarchy composed of lower hierarchy rank sub menus such as first lower hierarchy rank sub menus and second lower hierarchy rank sub menus . . . is formed.

It should be noted that in the sub menus and the lower hierarchy rank sub menus, there are a sub menu management file related to the sub menus at the same hierarchy rank (for example, the sub menu management files 91-1 to 91-n) and a lower hierarchy sub menu management file related to the lower hierarchy sub menus at the same hierarchy rank (for example, the first lower hierarchy rank sub menus 92-1 to 92-n), respectively.

In the case of the example of the category identification information 1, Mail is stored while being associated therewith as the main menu and also Mail box, Composition, New mail reception, Draft . . . are stored while being associated therewith as the sub menus.

Furthermore, Mail box that functions as one sub menu of the plurality of sub menus stores, as the first lower hierarchy rank sub menu, the first lower hierarchy rank sub menu 1, the first lower hierarchy rank sub menu 2, . . . while being associated therewith. In the sub menu, there is a sub menu management file 91-1 related to the sub menus at the same hierarchy rank, and in the first lower hierarchy rank, there is a lower hierarchy rank sub menu management file 92-1 related to the lower hierarchy rank sub menus at the same hierarchy rank.

In the case of the example of the category identification information 2, Mail is stored while being associated therewith as the main menu and also Owner information, Address directory, New registration, Call history, . . . are stored while being associated therewith.

Furthermore, owner information that functions as one sub menu of the plurality of sub menus stores, as the first lower hierarchy rank sub menus, the first lower hierarchy rank sub menu 1, the first lower hierarchy rank sub menu 2, . . . while being associated therewith. In the sub menu, there is a sub menu management file 91-2 related to the sub menus at the same hierarchy rank, and in the first lower hierarchy rank, there is a lower hierarchy rank sub menu management file 92-2 related to the lower hierarchy rank sub menus at the same hierarchy rank.

In the case of the example of the category identification information n, Main menu is stored while being associated therewith as the main menu n and also a sub menu 1, a sub menu 2, a sub menu 3, a sub menu 4 . . . are stored while being associated therewith as the sub menus.

Furthermore, the sub menu 1 that functions as one sub menu of the plurality of sub menus stores, as the first lower hierarchy rank sub menus, the first lower hierarchy rank sub menu 1, the first lower hierarchy rank sub menu 2, . . . while being associated therewith. In the sub menu, there is a sub menu management file 91-n related to the sub menus at the same hierarchy rank, and in the first lower hierarchy rank, there is a lower hierarchy rank sub menu management file 92-n related to the lower hierarchy rank sub menus at the same hierarchy rank.

It should be noted that the sub menu management files 91-1 to 91-n are collectively referred to as the sub menu management file 91 when the distinction is unnecessary in the following description. Further, the lower hierarchy rank sub menu management files 92-1 to 92-n are collectively referred to the lower hierarchy rank sub menu management file 92 as when the distinction is unnecessary in the following description.

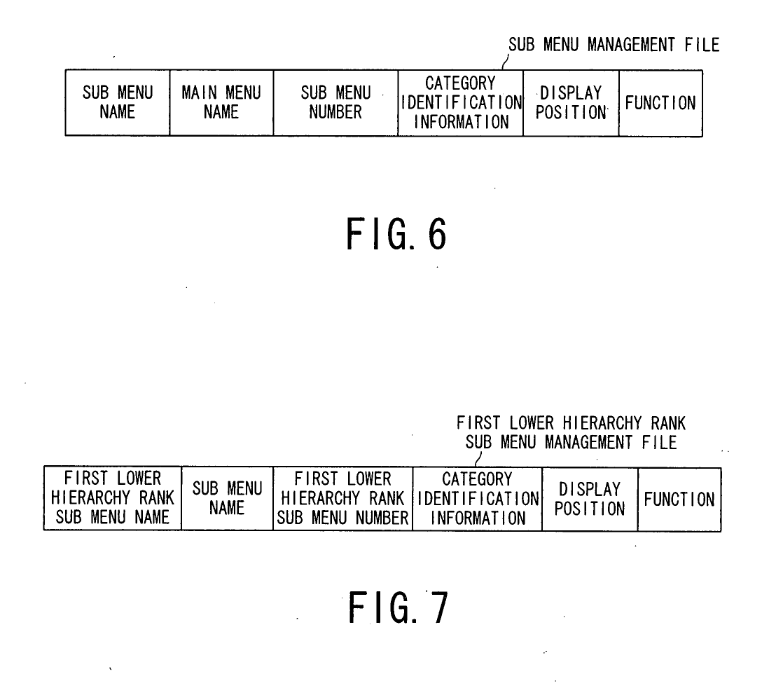

Next, with reference to FIG. 6, a configuration of the sub menu management file will be described.

As shown in FIG. 6, the sub menu management file is composed of the sub menu name at the same hierarchy, the main menu name stored while being associated with the sub menu, the sub menu number allocated to the sub menu, the category information while being associated with the sub menu, the display position indicating a position to be displayed among the plurality of the sub menus, and the function previously associated with the sub menu (for example, the application program, the display screen, the setting screen, the task, and the like).

It should be noted that in the sub menu management file, the sub menu management file for each of the sub menus at the same hierarchy rank is created and managed.

Next, with reference to FIG. 7, a configuration of a first lower hierarchy rank sub menu management file will be described. It should be noted that configurations of the lower hierarchy rank sub menu management file from the second lower hierarchy rank are the same as that of the first lower hierarchy rank sub menu management file, and a description thereto will be omitted to avoid the repetition.

As shown in FIG. 7, the first lower hierarchy rank sub menu management file is composed of a first lower hierarchy rank sub menu name at the same hierarchy rank, a sub menu name stored while being associated with the first lower hierarchy rank sub menu, a first lower hierarchy rank sub menu number of the first lower hierarchy rank sub menu, category identification information stored while being associated with the first lower hierarchy rank sub menu, a display position indicating a position to be displayed among the plurality of first lower hierarchy rank sub menus, and functions that are previously associated with the first lower hierarchy rank sub menu (for example, the application programs, the display screen, the setting screen, the task, and the like).

It should be noted that in the first lower hierarchy rank sub menu management file, the first lower hierarchy rank sub menu management file for each of the first lower hierarchy rank sub menus at the same hierarchy is created and managed.

Furthermore, the memory unit 72 stores a prescribed sub menu management table. In the prescribed sub menu management table, the prescribed sub menu in which the category identification information to be associated in the sub menu registration process is previously determined, a type of the prescribed sub menu, and the category identification information stored while being associated with the prescribed sub menu are registered while being associated therewith.

The prescribed sub menu determination unit 73 obtains the new sub menu supplied from the new sub menu selection reception unit 81, and at the same time, reads out the prescribed sub menu management table stored in the memory unit 72 and refers to the read prescribed sub menu management table to determine whether or not the thus obtained new sub menu management table is the prescribed sub menu management table.

In a case where the thus obtained new sub menu is determined to be the prescribed sub menu, the prescribed sub menu determination unit 73 generates a determination instruction signal indicating such the determination that the thus obtained new sub menu is the prescribed sub menu and supplies the generated determination instruction signal to the memory unit 72 and a type recognition unit 74.

It should be noted that the determination instruction signal also includes data related to the thus obtained new sub menu.

In a case where it is determined that the thus obtained new sub menu is not the prescribed sub menu, the prescribed sub menu determination unit 73 generates a determination instruction signal indicating such the determination that the thus obtained new sub menu is not the prescribed sub menu and supplies the generated determination instruction signal to the memory unit 72.

The type recognition unit 74 recognizes, on the basis of the determination instruction signal (the determination instruction signal indicating it is determined that the thus obtained new sub menu is the prescribed sub menu) supplied from the prescribed sub menu determination unit 73, and that the obtained new sub menu is the prescribed sub menu.

At the same time, the type recognition unit 74 reads out the prescribed sub menu management table stored in the memory unit 72 to refer to the read prescribed sub menu management table, and recognizes a type of the new sub menu on the basis of the data about the new sub menu included in the determination instruction signal. The type recognition unit 74 generates a recognition instruction signal representing the recognition result, and supplies the thus generated recognition instruction signal to a category identification information setting unit 75.

The category identification information setting unit 75 reads out the prescribed sub menu management table stored in the memory unit 72 so as to refer to the read prescribed sub menu management table.

On the basis of the recognition instruction signal supplied from the type recognition unit 74, the category identification information setting unit 75 sets the category identification information to be stored while being associated with the new sub menu and supplies the category identification information setting data related to the set category identification information to the memory unit 72.

The display control unit 76 reads out, on the basis of the selections supplied from the selection accept unit 71, the information stored in the memory unit 72 and displays the read information on the liquid crystal display 34. Further, the display control unit 76 displays, when necessary, various dialogs on the liquid crystal display 34.

The function execution control unit 77 is composed of a function screen display control unit 83, an application program execution control unit 84, and the like, and controls the execution of the functions that are previously associated with the sub menus and the lower hierarchy rank sub menus (for example, the application programs, the display screen, the setting screen, the task, and the like).

The function screen display control unit 83 reads out, on the basis of the various selections supplied from the sub menu selection reception unit 79 of the selection accept unit 71 and the lower hierarchy rank sub menu selection reception unit 80, the display screen, the setting screen, and the like which are stored in the memory unit 72 to control the display of the read display screen, the setting screen, etc.

The application program execution control unit 84 reads the various application programs stored in the memory unit 72 on the basis of the various selections supplied from the sub menu selection reception unit 79 of the selection accept unit 71 and the lower hierarchy rank sub menu selection reception unit 80, and controls the execution of the read application program.

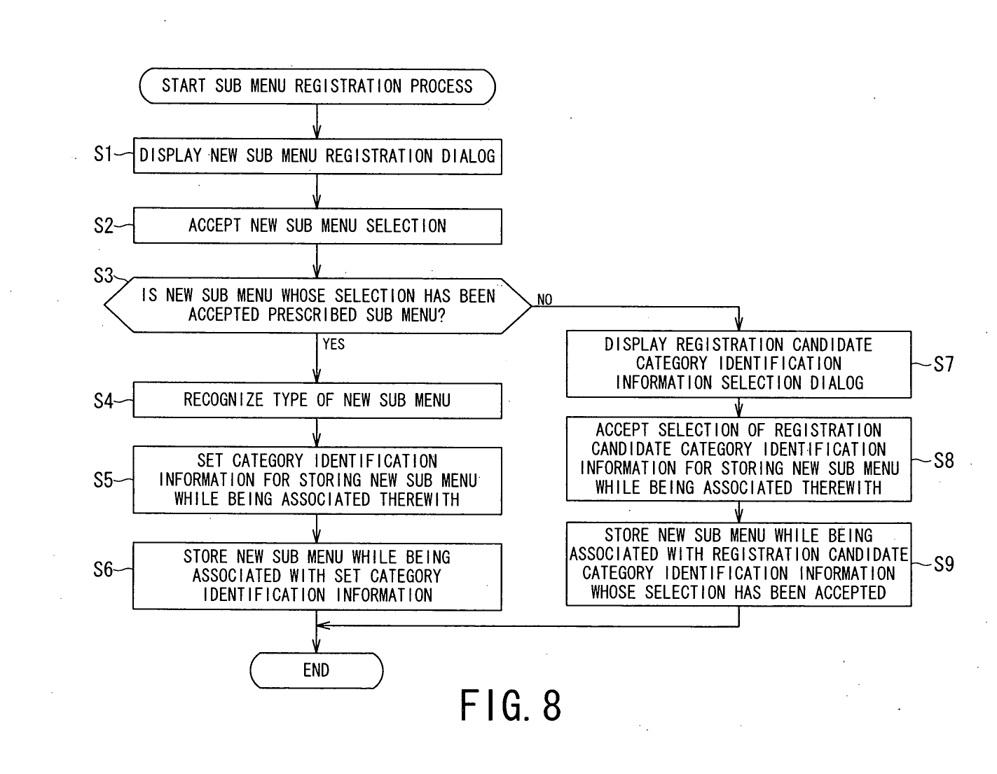

With reference to a flowchart of FIG. 8, the sub menu registration process of the camera-equipped digital mobile phone 15 of FIG. 4 will be described. It should be noted that the sub menu registration process is started after the user operates the operation key 36 to issue an instruction of starting the sub menu registration process.

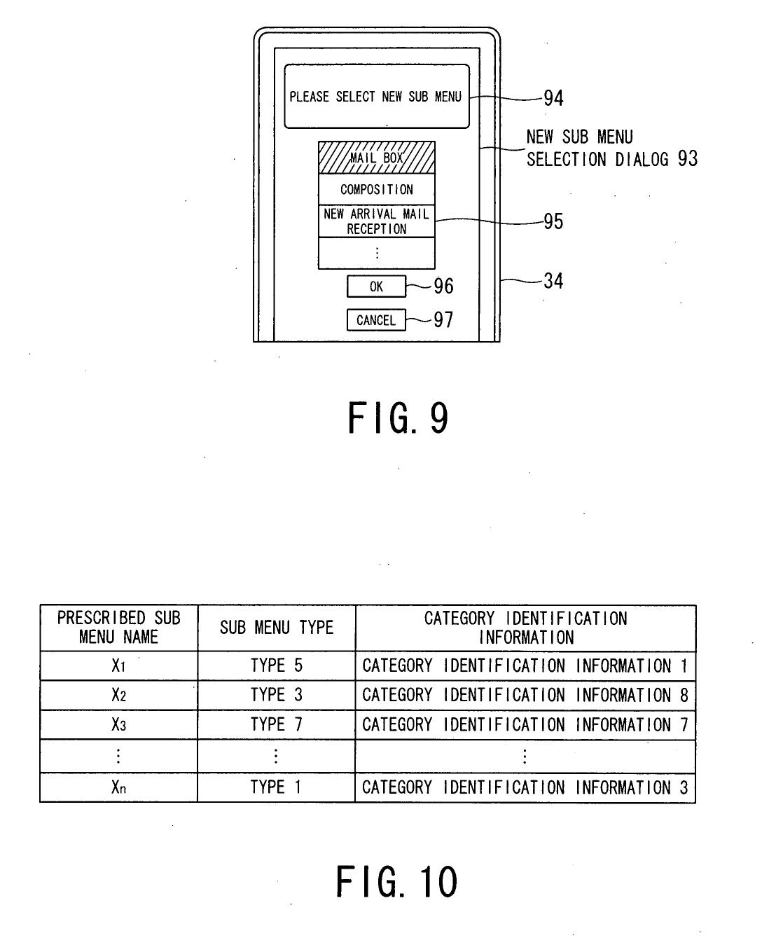

In Step S1, the display control unit 76 displays a new sub menu selection dialog for registering a new sub menu on the liquid crystal display 34. The liquid crystal display 34 displays, in accordance with the control of the display control unit 76, a new sub menu selection dialog 93 shown in FIG. 9.

FIG. 9 shows a display example of the new sub menu selection dialog 93 to be displayed on the liquid crystal display 34.

The new sub menu selection dialog 93 of FIG. 9 includes a message display field 94, a selection field 95, a command display field 96 and a command display field 97 that display commands.

In the case of the example of FIG. 9, on the message display field 94, “Please select a new sub menu” is displayed as a message. With this configuration, the user understands that it is possible to select a new sub menu.

The selection field 95 is a field for accepting the various new sub menu selections that are not registered through the operation of the arrow key in the operation key 36 by the user, for example. In the case of the example of FIG. 9, as the new sub menus, “Mail box”, “Composition”, “New arrival mail” . . . are displayed on the selection field 95, and at the same time, the part “Mail box” is focused on.

When, for example, the enter key in the operation key 36 is operated as the new sub menus by the user, “Mail box” is selected. It should be noted that when the user operates, for example, the arrow key in the operation key 36 in the up and down directions (scrolled), new sub menus that are firstly not displayed on the selection field 95 are sequentially displayed. It is needless to mention that a desired new sub menu name may be input directly as the user operates the operation key 36.

The command display field 96 and the command display field 97 respectively have “OK” and “cancel” command icons. The user selects, through the operation of the operation key 36, the command icon for “OK” of the command display field 96, thus making it possible to instruct the new sub menu registration. In addition, the user selects, through the operation of the operation key 36, the command icon for “cancel” on the command display field 97, thus making it possible to cancel the new sub menu registration process.

On the basis of the new sub menu selection dialog 93 in FIG. 9, the new sub menu selection reception unit 81 determines whether or not the new sub menu registration is instructed while the user operates the operation key 36 to select the “OK” icon on the command display field 96.

In a case where the user selects the “OK” icon on the command display field 96 through the operation of the operation key 36, the new sub menu selection reception unit 81 determines that the new sub menu registration is instructed while the user operates the operation key 36 to select the “OK” on the command display field 96.

On the other hand, in a case where the user selects the icon of “cancel” on the command display field 97 through the operation of the operation key 36, the new sub menu selection reception unit 81 determines that the new sub menu registration is cancelled as the user operates the operation key 36 to select the icon of “cancel” on the command display field 97.

In Step S2, when the user operates the operation key 36 to select the “OK” on the command display field 96 and it is determined that the new sub menu registration is instructed, the new sub menu selection reception unit 81 accepts the non-registered new sub menu that has been selected on the selection field 95.

The new sub menu selection reception unit 81 supplies the new sub menu whose selection has been accepted to the memory unit 72 and the prescribed sub menu determination unit 73.

In Step S3, the prescribed sub menu determination unit 73 obtains the new sub menu supplied from the new sub menu selection reception unit 81, and at the same time reads out the prescribed sub menu management table stored in the memory unit 72 and refers to the read prescribed sub menu management table to determine whether or not the thus obtained new sub menu management table is the prescribed sub menu management table.

FIG. 10 shows a configuration example of the prescribed sub menu management table stored in the memory unit 72.

In the first column to the third column in the prescribed sub menu management table of FIG. 10, “prescribed sub menu name”, “Sub menu type”, and “category identification information” are described, which respectively indicate a name of a prescribed sub menu, a type of a sub menu, and category identification information previously determined to be stored in association with the prescribed sub menu.

In the case of the first row in FIG. 10, it shows that “prescribed sub menu name” is “X1” and the name of the prescribed sub menu is “X1”. It also shows that “Sub menu type” is “type 5” and the type of the sub menu is “type 5”. Furthermore, it shows that “category identification information” is “category identification information 1” and the category identification information previously determined to be stored while being associated with the prescribed sub menu is “category identification information 1”.

In the case of the second row in FIG. 10, it shows that “prescribed sub menu name” is “X2” and the name of the prescribed sub menu is “X2”. In addition, it shows that “Sub menu type” is “type 3” and the type of the sub menu is “type 3”. Further, it shows that “category identification information” is “category identification information 8” and the category identification information previously determined to be stored while being associated with the prescribed sub menu is “category identification information 8”.

It should be noted that the third row and the following rows in FIG. 10 are basically the same as those of the first and second rows in FIG. 10, and a description thereto will be hence omitted to avoid the repetition.

For example, when the name of the new sub menu is “X2”, it is determined that the thus obtained new sub menu is the new sub menu. On the other hand, when the name of the new sub menu is not any one of “X1” to “Xn”, it is determined that the thus obtained new sub menu is not the new sub menu.

In a case where the new sub menu obtained in Step S3 is determined to be the prescribed sub menu, the prescribed sub menu determination unit 73 generates a determination instruction signal indicating that it is determined that the thus obtained new sub menu is the prescribed sub menu, and supplies the generated determination instruction signal to the memory unit 72 and the type recognition unit 74. It should be noted that the determination instruction signal also includes data related to the thus obtained new sub menu.

In Step S4, the type recognition unit 74 recognizes, on the basis of the determination instruction signal (a determination instruction signal indicating it is determined that the thus obtained new sub menu is the prescribed sub menu) supplied from the prescribed sub menu determination unit 73, that the new sub menu is the prescribed sub menu, and at the same time, reads out the prescribed sub menu management table stored in the memory unit 72 to refer to the read prescribed sub menu management table for recognizing the type of the new sub menu on the basis of the data about the name of the new sub menu that is included the determination instruction signal.

To be more specific, when the name of the new sub menu is “X2”, the type of the sub menu is recognized as “type 3”.

The type recognition unit 74 generates the recognition instruction signal representing the recognition result, and supplies the thus generated recognition instruction signal to the category identification information setting unit 75.

In Step S5, the category identification information setting unit 75 reads out the prescribed sub menu table stored in the memory unit 72 to refer to the read, prescribed sub menu management table, and sets on the basis of the recognition instruction signal supplied from the type recognition unit 74, the category identification information to be stored while being associated with the new sub menu.

To be more specific, when the new sub menu is “X2”, the category identification information to be stored while being associated with the new sub menu is set as “category identification information 8”.

The category identification information setting unit 75 supplies the category identification information setting data related to the set category identification information to the memory unit 72.

In Step S6, the memory unit 72 obtains the new sub menu supplied from the new sub menu selection reception unit 81, and at the same time, obtains the category identification information setting data supplied from the category identification information setting unit 75.

Then, the thus obtained new sub menu is stored so as to be associated with the category identification information that is set on the basis of the thus obtained category identification information setting data.

It should be noted that at this time, in the memory unit 72, the new sub menu management file 91 associated with the new sub menu is generated and stored with the sub menu management file 91.

With this configuration, when the sub menu that the user desires to newly register is the prescribed sub menu, it is possible to store the various functions previously associated with the sub menu that is desired to be newly registered while being associated with the category identification information previously determined by the prescribed sub menu management table together with the sub menu.

Therefore, when the user registers the new sub menu, by only selecting the sub menu that is desired to be newly registered, it is possible to automatically store the new sub menu while being associated with preferred category identification information. As a result, in a case where a plurality of functions mounted to the information processing device are utilized, the operability can be improved.

On the other hand, in Step S3, in a case where it is determined that the thus obtained new sub menu is not the prescribed sub menu, the prescribed sub menu determination unit 73 generates the determination instruction signal indicating that it is determined that the thus obtained new sub menu is not the prescribed sub menu, and supplies the generated determination instruction signal to the memory unit 72.

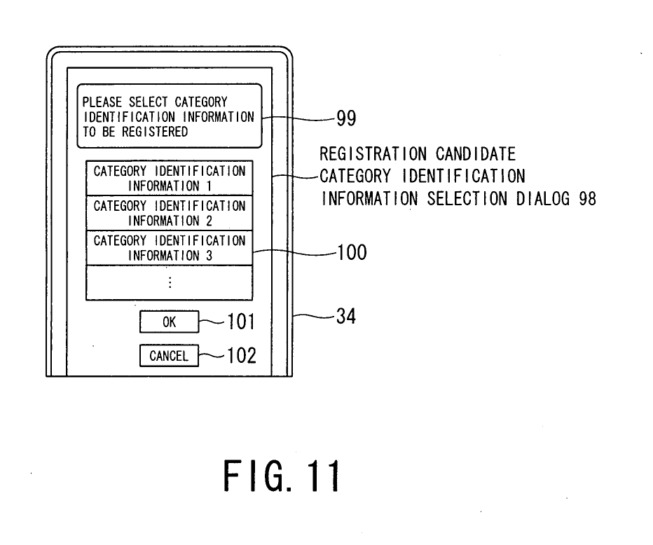

In Step S7, the display control unit 76 displays on the liquid crystal display 34 a registration candidate category identification information selection dialog 98 for requesting the selection of the registration candidate category identification information that is a candidate of the category identification information to be registered while being associated with the new sub menu that is not the prescribed sub menu. The liquid crystal display 34 displays, in accordance with the control of the display control unit 76, the registration candidate category identification information selection dialog 98 shown in FIG. 11.

FIG. 11 shows a display example of the registration candidate category identification information selection dialog 98 displayed on the liquid crystal display 34.

The registration candidate category identification information selection dialog 98 of FIG. 11 includes a message display field 99, a selection field 100, and a command display field 101 and a command display field 102 that display commands.

In the case of the example of FIG. 11, on the message display field 99, “Please select category identification information to be registered” is displayed as a message. With this configuration, the user understands that it is possible to select the registration candidate category identification information.

The selection field 100 is a field for accepting, in response to the operations of the operation keys 36 by the user, the selection of the registration candidate category identification information for registration while being associated with a new sub menu that is not a prescribed sub menu.

In the case of the example of FIG. 11, as the registration candidate category identification information, “category identification information 1”, “category identification information 2”, “category identification information 3” . . . are displayed on the selection field 100, and at the same time, the part “category identification information 1” is focused on. Thus, when the user operates the enter key in the operation key 36, for example, “category identification information 1” is selected as the registration candidate category identification information.

It should be noted that when the user operates, for example, the arrow key in the operation key 36 in the up and down directions (scrolled), pieces of the registration candidate category identification information that are not firstly displayed on the selection field 100 are sequentially displayed.

It is needless to say that, the user may directly input the desired registration candidate category identification information (for example, category identification information 7 or the like) through the operation of the operation key 36.

The command display field 101 and the command display field 102 respectively have command icons for “OK” and “cancel”. While the user selects the command icon for “OK” on the command display field 101 through the operation of the operation key 36, thus making it possible to instruct the selection of the registration candidate category identification information.

Moreover, the user selects the command icon for “cancel” on the command display field 102 through the operation of the operation key 36, thus making it possible to cancel the selection of the registration candidate category identification information.

The registration candidate category identification information selection accept unit 82 determines whether or not the selection of the registration candidate category identification information has been instructed when the user operates the operation key 36 to select the command icon for “OK” on the command display field 101 on the basis of a registration category identification information selection dialog 98 of FIG. 11.

In a case where the user selects the “OK” icon on the command display field 102 through the operation of the operation key 36, the registration candidate category identification information selection accept unit 82 determines that the selection of the registration candidate category identification information is instructed while the user operates the operation key 36 to select the command icon for “OK” on the command display field 101.

On the other hand, in a case where the user selects the command icon for “cancel” on the command display field 102 through the operation of the operation key 36, the registration candidate category identification information selection accept unit 82 determines that the selection of the registration candidate category identification information is cancelled while the user operates the operation key 36 to select the command icon for “cancel” on the command display field 102.

In Step S8, when it is determined that the user operates the operation key 36 to select the command icon for “OK” on the command display field 101 and the selection of the registration candidate category identification information is instructed, the registration candidate category identification information selection accept unit 82 accepts the registration candidate category identification information that has been selected in n Step S8.

The registration candidate category identification information selection accept unit 82 supplies the registration candidate category identification information whose selection is accepted to the memory unit 72.

In Step S9, the memory unit 72 recognizes, on the basis of the determination instruction signal (the determination instruction signal indicating that it is determined that the thus obtained new sub menu is not the prescribed sub menu) supplied from the prescribed sub menu determination unit 73, that the thus obtained new sub menu is not the prescribed sub menu and obtains the new sub menu supplied from the new sub menu selection reception unit 81.

At the same time, the memory unit 72 obtains the registration candidate category identification information supplied from the registration candidate category identification information selection accept unit 82 and stores the thus obtained new sub menu while being associated with the registration candidate category identification information.

It should be noted that at this time, in the memory unit 72, the sub menu management file 91 associated with the new sub menu is generated and stored together with the sub menu management file 91.

With this configuration, when the sub menu that the user desires to newly register is not the prescribed sub menu, it is possible to store the various functions that are previously associated with the sub menu desired to be newly registered together with the sub menu while being associated with the desired category identification information.

Therefore, the user can store the functions while being associated with the category identification information suitable to the type of the new sub menu to be newly registered, whereby it is possible to arbitrarily sort out groups in terms of functions previously associated with the new sub menu. As a result, the operability can be improved in a case where a plurality of functions that are mounted to the information processing device are utilized.

It should be noted that, in the sub menu registration process described with reference to the flowchart of FIG. 8, the new sub menu is to be registered, but the configuration is not limited to such a case, and for example, a new lower hierarchy rank sub menu or the like may be newly registered, or the category identification information with which the previously set sub menu or the like is associated may be charged and registered. With this configuration, in accordance with a preference of the user, it is possible to arbitrarily sort out groups in terms of functions previously associated with the new sub menu. Therefore, in a case where a plurality of functions that are mounted to the information processing device are utilized, the operability can be further improved.

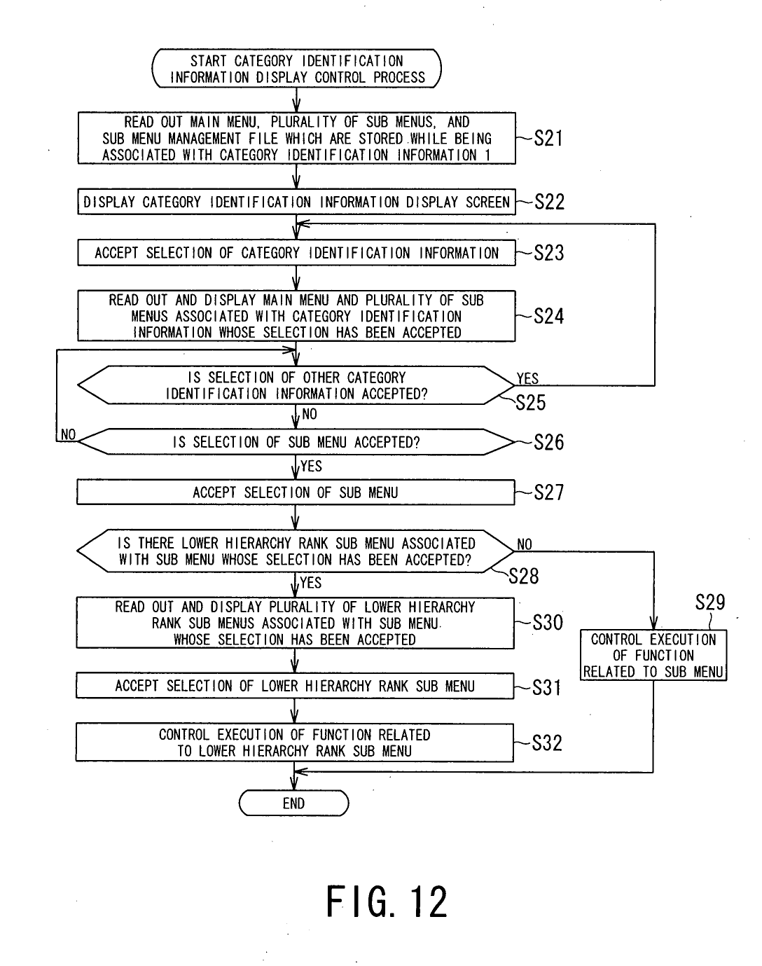

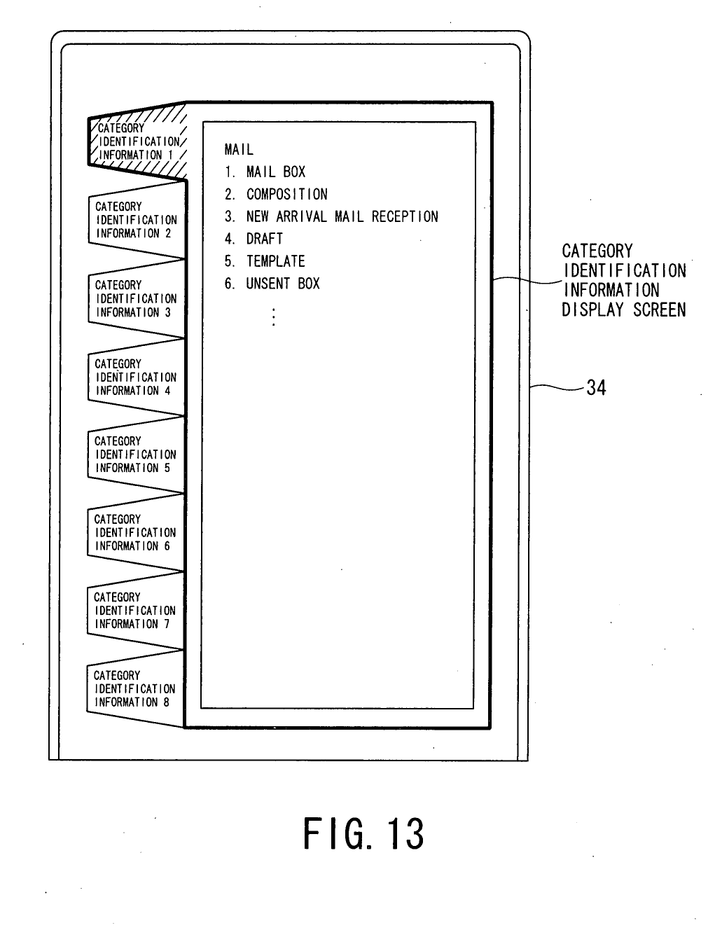

Next, with reference to a flowchart of FIG. 12, a category identification information display control process in the camera-equipped digital mobile phone 15 of FIG. 4 will be described.

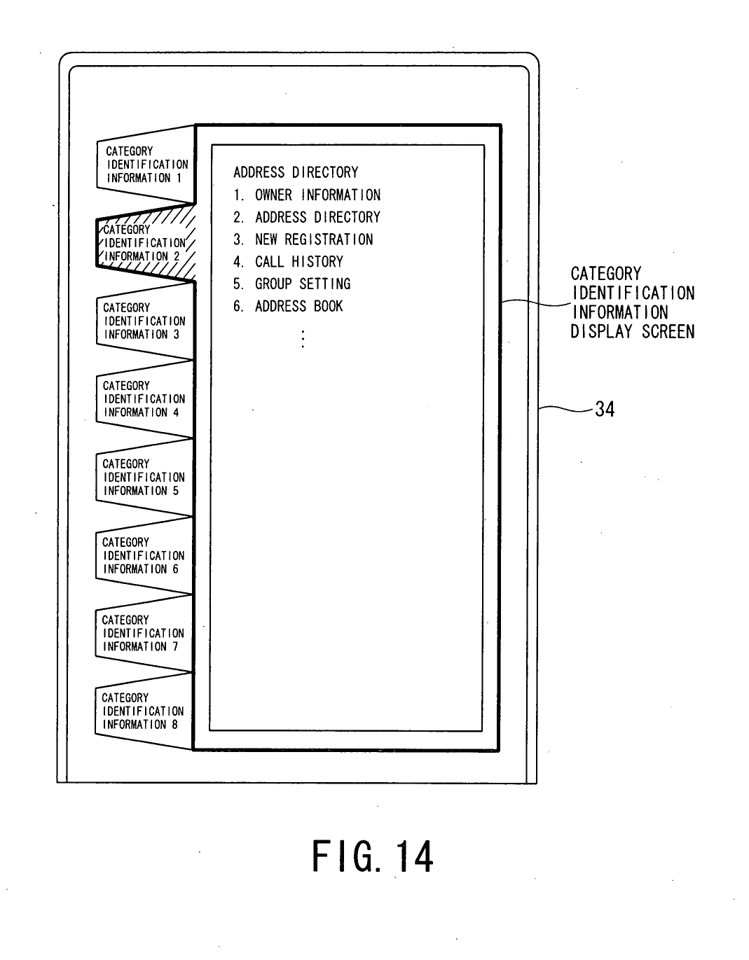

In this category identification information display control process, when the user operates the enter key in the operation key 36 on the standby display, for example, the category identification information display control process is started after the starting of the category identification information display control process is instructed, for example, a category identification information display screen shown in FIG. 13 is displayed on the liquid crystal display 34.

It should be noted that on the standby display, as the user operates a short cut key or the like of the operation key 36, for example, the category identification information display control process is started and, for example, the category identification information display screen shown in FIG. 13 may be displayed on the liquid crystal display 34.

In Step S21, the display control unit 76 reads out a main menu, a plurality of sub menus, and a sub menu management file which are stored in the memory unit 72 while being associated with the category identification information 1.

In Step S22, the display control unit 76 displays the category identification information display screen related to the category identification information 1 on the basis of the read category which are associated with the read category identification information, the main menu, the plurality of sub menus, and the sub menu management file.

FIG. 13 shows a display example of the category identification information display screen displayed on the liquid crystal display 34.

As shown in FIG. 13, regarding the category identification information 1, “Mail” is displayed as the main menu while being associated therewith, and at the same time “Mail box”, “Composition”, “New mail reception”, “Draft”, “Template”, “Unsent box”, . . . are sequentially displayed as the sub menus.

It should be noted that, in order to indicate that the category identification information display screen related to the category identification information 1 is currently displayed, the category identification information 1 is focused on.

In Step S23, the category identification information selection accept unit 78 accepts the selection of the category identification information indicating the category of the main menu desired by the user as the user operates the arrow key of the operation key 36, for example.

To be more specific, in the case of the example of FIG. 13, the category identification information selection accept unit 78 accepts the selection of the category identification information of one of the category identification information 1 to 8.

The category identification information selection accept unit 78 supplies the category identification information whose selection has been accepted to the display control unit 76.

In Step S24, the display control unit 76 obtains category identification information supplied from the category identification information selection accept unit 78 and reads out the main menu, a plurality of sub menus, and the sub menu management file associated with the thus obtained category identification information.

On the basis of the main menu while being associated with the read category identification information, a plurality of sub menus and the sub menu management file, the category identification information display screen related to the category identification information whose selection has been received is displayed. The liquid crystal display 34 displays, in accordance with the control of the display control unit 76, the category identification information display screen related to the category identification information whose selection has been received.

For example, as the user operates the arrow key of the operation key 36, for example, when the selection of category identification information 2 is accepted in the category identification information selection accept unit 78, as shown in FIG. 14, the category identification information display screen related to the category identification information 2 is displayed. FIG. 14 shows a display example of the category identification information display screen displayed on the liquid crystal display 34.

As shown in FIG. 14, regarding the category identification information 2, “Address directory” is displayed as the main menu while being associated therewith, and the same time, “Owner information”, “Address directory”, “New registration”, “Call history”, “Group setting”, “Address book”, . . . as the sub menus are sequentially displayed.

Furthermore, in order to indicate that the category identification information display screen related to the category identification information 2 is currently displayed, the category identification information 2 is focused on.

In Step S25, the category identification information selection accept unit 78 determines whether or not the selection of other category identification information has been accepted in response to the operations of the operation keys 36 by the user.

In Step S25, when it is determined that the selection of other category identification information is accepted, the process is returned to Step S23 to repeatedly execute the same process in Step S23 and the subsequent steps.

For example, according to the operation of the user of the arrow key of the operation key 36, for example, the selection of the category identification information 2 is accepted in the category identification information selection accept unit 78. Thereafter, when the selection of the category identification information 5 is accepted, the category identification information display screen related to the category identification information 5 is displayed, instead of the category identification information display screen related to the category identification information 2. Thereafter, the same process is repeatedly execute.

With this configuration, even in a case where a plurality of functions are mounted to the information processing device, the user can display the menu associated with the desired function in a short period of time. In addition, even if the menu associated with the undesired function is displayed by a mistake in the first operation, it is possible to immediately display the menu associated with the desired function in a short period of time. Therefore, the operability can be improved in a case where a plurality of functions mounted to the information processing device are utilized.

In Step S25, when it is determined that the selection of other category identification information is not accepted, in Step S26, the sub menu selection reception unit 79 determines whether or not the selection of the sub menu has been accepted in response to the operations of the operation keys 36 by the user.

In Step S26, when it is determined that the selection of the sub menu is not accepted, the process is returned to Step S25, the process in Step S25 and subsequent step is repeatedly performed.

With this configuration, until one of the sub menus displayed on the category identification information display screen is selected as the user operates the arrow key of the operation key 36, for example, the category identification information display screen related to the respective category identification information can be repeatedly displayed.

On the other hand, in Step S26 when it is determined that the selection of the sub menu has been accepted, the sub menu selection reception unit 79 accepts the selection of one of a plurality of sub menus related to the main menu in Step S27 as the user operates the arrow key and the enter key of the operation key 36, for example.

To be more specific, in a case where the selection of the category identification information 7 has been accepted in the category identification information selection accept unit 78, and the category identification information display screen related to the category identification information 7 is displayed, the sub menu selection reception unit 79 accepts, in response to the operations of the operation keys 36 by the user, the selection of the sub menu among the plurality of displayed sub menus (including “Alarm”, “Simple answering machine”, “Memo pad”, “Simplified calculator”, “Dictionary”, “Calendar”, and the like).

The sub menu selection reception unit 79 supplies the sub menu whose selection has been accepted to the display control unit 76 and the function execution control unit 77.

In Step S28, the display control unit 76 obtains the sub menu whose selection has been accepted from the sub menu selection reception unit 79 and determines whether or not a lower hierarchy rank sub menu associated with the sub menu whose selection has been accepted exists.

In Step S28, when it is determined that the lower hierarchy rank sub menu associated with the sub menu whose selection has been accepted does not exist, the display control unit 76 generates a determination instruction signal indicating the determination that the lower hierarchy rank sub menu and supplies the signal to the function execution control unit 77.

In Step S29, on the basis of the determination instruction signal (the determination instruction signal indicating that it is determined that the lower hierarchy rank sub menu associated with the sub menu whose selection has been accepted does not exist) supplied from the display control unit 76, the function execution control unit 77 recognizes that the lower hierarchy rank sub menu associated with the sub menu whose selection has been accepted does not exist, and controls the execution of the function related to the sub menu whose selection has been accepted.

That is, in a case where the function related to the sub menu whose selection has been accepted is the display screen, the setting screen or the like, the function screen display control unit 83 of the function execution control unit 77 obtains the sub menu whose selection has been accepted from the sub menu selection reception unit and reads out the display screen, the setting screen, or the like associated with the sub menu whose selection has been accepted from the memory unit 72, thus controlling the display of the read display screen, the setting screen, or the like.

Then, in a case where the function related to the sub menu whose selection has been accepted is the application program, the application program execution control unit 84 of the function execution control unit 77 obtains the sub menu selection reception unit 79 from the sub menu whose selection has been accepted and reads out the application program associated with the sub menu whose selection has been accepted from the memory unit 72 to thereby control the execution of the read application program.

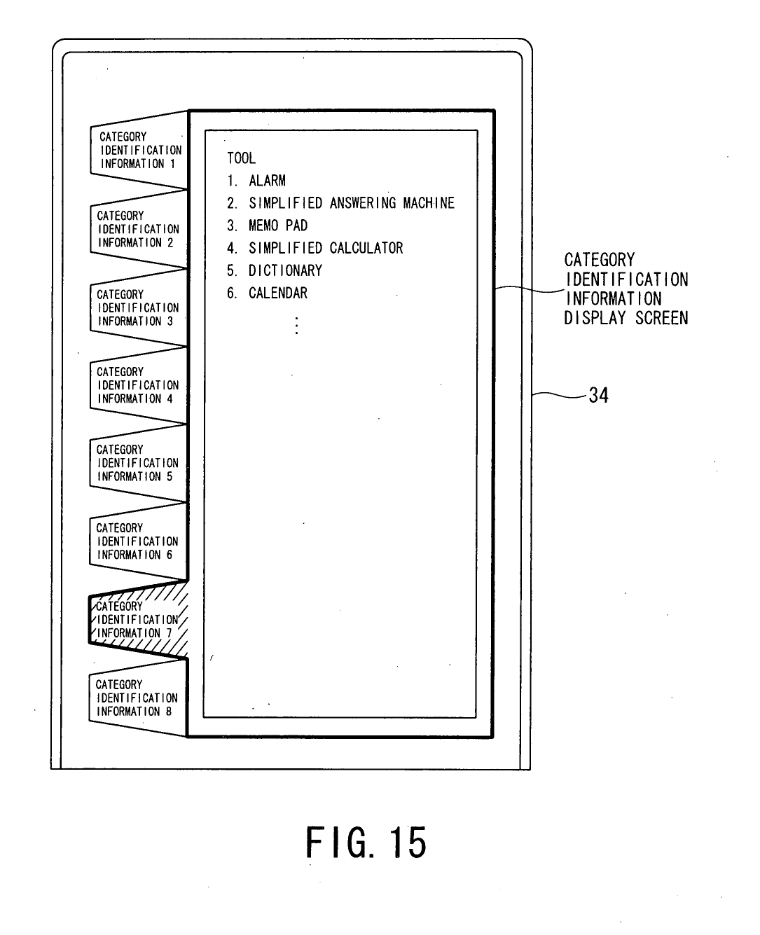

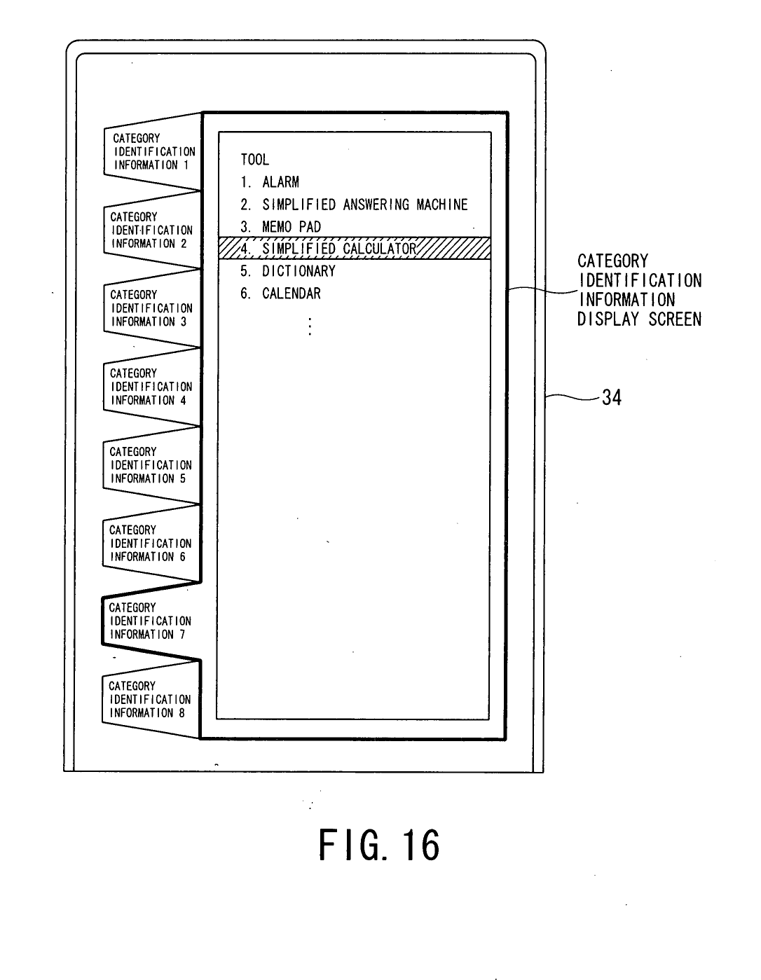

In the case of the example of FIG. 15, the user operates the arrow key and the enter key of the operation key 36, for example, among the plurality of displayed sub menus, and the selection of the sub menu “Simplified calculator” is accepted.

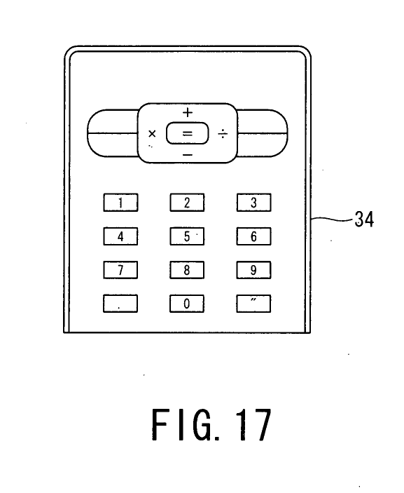

At that time, as shown in FIG. 16, from the state of focusing on the category identification information 7, the state is shifted such that the sub menu part “Simplified calculator” is focused on. Thereafter, in an application program execution control unit 77, the execution of the application program in the simplified calculator associated with the sub menu “Simplified calculator” is controlled, and as shown in FIG. 17, an input assistance screen of the simplified calculator is displayed on the liquid crystal display 34.

On the other hand, in Step S28, when it is determined that the lower hierarchy rank sub menu associated with the sub menu whose selection has been accepted exists, in Step S30, the display control unit 76 generates the determination instruction signal indicating that the menu is the lower hierarchy rank sub menu associated with the sub menu whose selection has been accepted, and then, supplies the signal to the function execution control unit 77.

At the same time, the display control unit 76 reads out the sub menu whose selection has been accepted from the sub menu selection reception unit 79 and the plurality of lower hierarchy rank sub menus associated with the sub menu whose selection has been accepted and the lower hierarchy rank sub menu management file from the memory unit 72.

Further, on the basis of the determination instruction signal (the determination instruction signal indicating that the menu is the lower hierarchy rank sub menu associated with the sub menu whose selection has been accepted) supplied from the display control unit 76, the function execution control unit 77 recognizes that the menu is the lower hierarchy rank sub menu associated with the sub menu whose selection has been accepted and does not start the control of the function execution.

The display control unit 76 displays a lower hierarchy rank sub menu display screen on the basis of the plurality of lower hierarchy rank sub menus associated with the read sub menu and the lower hierarchy rank sub menu management file. The liquid crystal display 34 displays the lower hierarchy rank sub menu display screen in accordance with the control of the display control unit 76.

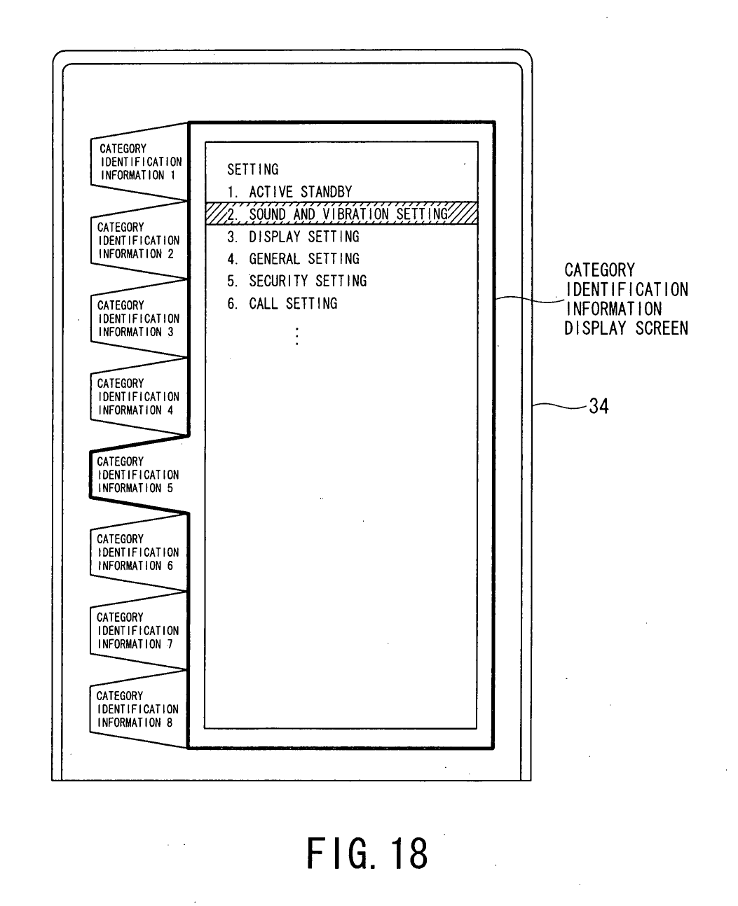

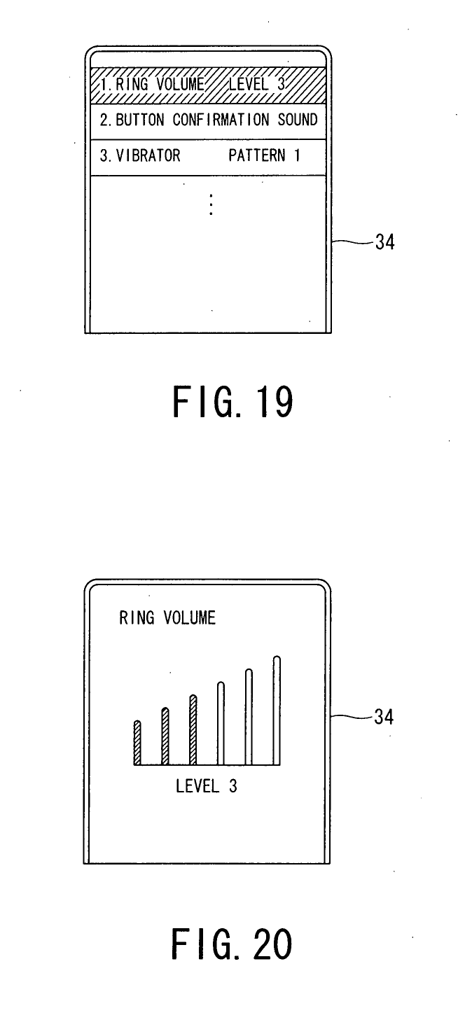

In the case of the example of FIG. 18, as the user operates the arrow key and the enter key of the operation key 36, the selection of the sub menu “Sound and vibration setting” is accepted, for example, among the plurality of displayed sub menus, from the state of focusing on the category identification information 5, the state is shifted such that the sub menu part “Sound and vibration setting” is focused on. Thereafter, the lower hierarchy rank sub menu display screen shown in FIG. 19 is displayed on the liquid crystal display 34.

As shown in FIG. 19, “Ring volume level 3”, “□ button confirmation sound”, “Vibrating pattern 1”, . . . are sequentially displayed as sub menus on the lower hierarchy rank sub menu display screen, by one lower hierarchy rank than the sub menu “Sound and vibration setting” (first lower hierarchy rank sub menus).

In Step S31, the lower hierarchy rank sub menu selection reception unit 80 accepts the selection of one of the plurality of low rank sub menus belonging to the lower rank of the sub menu as the user operates the arrow key and the enter key of the operation key 36, for example.

In the case of the example of FIG. 19, the lower hierarchy rank sub menu selection reception unit 80 accepts the selection of one lower hierarchy rank sub menu among the plurality of lower hierarchy rank sub menus (the lower hierarchy rank sub menus including, for example, “Ring volume level 3”, “□ button confirmation sound”, and “Vibrating pattern 1”).

A lower hierarchy rank sub menu selection reception unit 87 supplies the low rank sub menu whose selection has been accepted to the function execution control unit 77.

In Step S32, the function execution control unit 77 controls the execution of the function related to the lower hierarchy rank sub menu whose selection has been accepted.

That is, in a case where the function related to the lower hierarchy rank sub menu whose selection has been accepted is the display screen, the setting screen, or the like, the function screen display control unit 83 of the function execution control unit 77 obtains the low rank sub menu accepted from the lower hierarchy rank sub menu selection reception unit 80 and reads out the display screen, the setting screen, or the like associated with the lower hierarchy rank sub menu whose selection has been accepted from the memory unit 72 to control the display of the read display screen, the read setting screen, or the like.

Then, in a case where the function related to the lower hierarchy rank sub menu whose selection has been accepted is the application program, the application program execution control unit 84 of the function execution control unit 77 obtains the lower hierarchy rank sub menu selection reception unit 80 from the low rank sub menu whose selection has been accepted and reads out the application program associated with the lower hierarchy rank sub menu whose selection has been accepted from the memory unit 72 so as to control the execution of the read application program.

In the case of the example of FIG. 19, as the user operates the arrow key and the enter key of the operation key 36, for example, among the plurality of displayed lower hierarchy rank sub menus, when the selection of the lower hierarchy rank sub menu “Ring volume level 3” is accepted, the display control unit 76 displays a ring volume setting screen on the liquid crystal display 34. The liquid crystal display 34 displays the ring volume setting screen shown in FIG. 20.

FIG. 20 shows that the currently set ring volume is “level 3” on the ring volume setting screen. While the user operates the arrow key of the operation key 36, for example, it is possible to set the level of the ring volume, for example, level 4.

According to the embodiments of the present invention, the plurality of menus previously associated with the various functions are registered while being associated with the category identification information in advance, and the category identification information display screen related to the category identification information is displayed for each category identification information.

As a result, it is possible to repeatedly display the plurality of sub menus related to the category identification information in a short period of time. With this configuration, the function previously associated with the sub menus can be activated and executed in a short period of time. Therefore, the operability can be improved in a case where a plurality of functions that are mounted to the information processing device are utilized.

It should be noted that in the category identification information display control process described with reference to the flowchart of FIG. 12, the specific example has been described in which only the first lower hierarchy rank sub menu exists as the lower hierarchy rank sub menu. It is, however, needless to say that the present invention may also be applied in such a case that there are a plurality of lower hierarchy rank sub menus as the lower hierarchy rank sub menus.

Incidentally, in the category identification information display control process described with reference to the flowchart of FIG. 12, when the user is asked to select the category identification information, the sub menu, and the lower hierarchy rank sub menu, the arrow key or the like in the operation key 36 is used for the selection.

However, the user may adopt a method of combining a short press or a long press with the numeral keys used in the camera-equipped digital mobile phone 15 for the selection. With this configuration, in a case where a plurality of functions that are mounted to the information processing device are utilized, the operability can be further improved.

The category identification information display control process with the use of such a method will be described below.

Herein, “short press” means an operation of pressing one operation key continuously for a predetermined time set in advance, and on the other hand, “long press” means an operation of pressing one operation key continuously for a predetermined time set in advance longer than the time for “short press”.

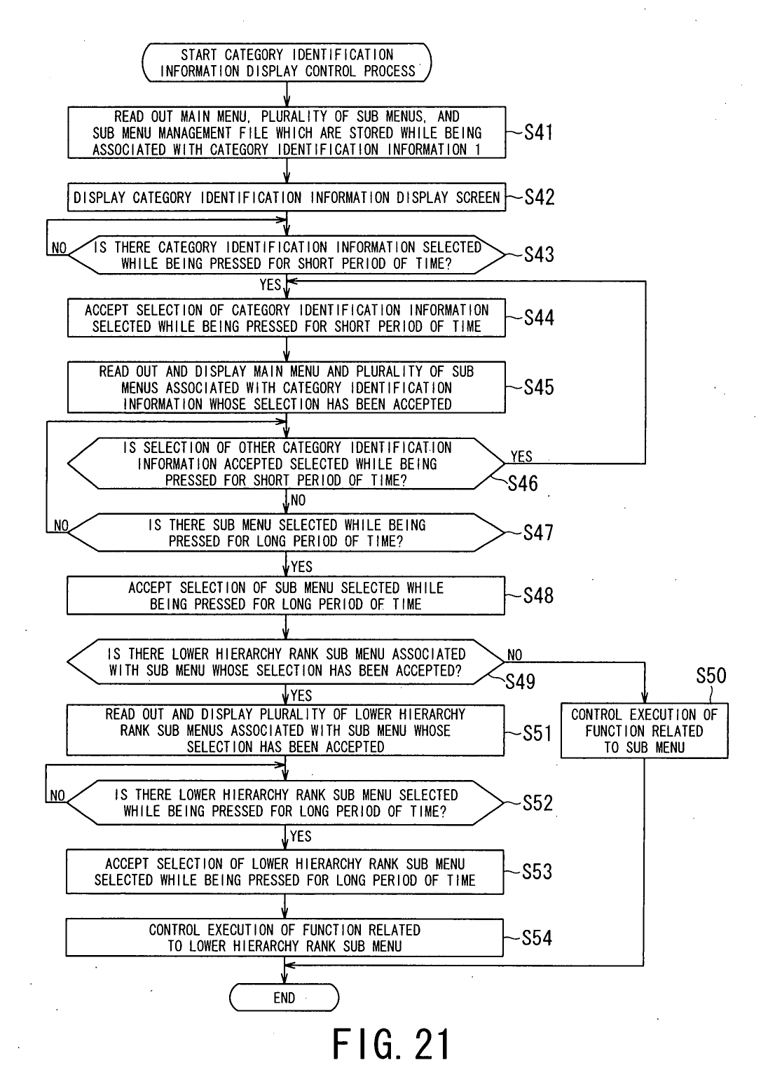

With reference to a flowchart of FIG. 21, there will be described another category identification information display control process in the camera-equipped digital mobile phone 15 of FIG. 4.

It should be noted that processes in Step S41, Step S42, Step S45, Steps S49 to S51, and Step S54 of FIG. 21 are the same as the processes in Step S21, Step S22, Step S24, Steps S28 to S30, and Step S32 of FIG. 12, so that a description thereto will be omitted herein to avoid the repetition.

Similarly to the category identification information display control process of FIG. 12, in the category identification information display control process shown in FIG. 21, after the starting of the category identification information display control process is instructed and the process is started as the user operates the enter key or the short cut key in the operation key 36 on the standby display, for example, the category identification information display screen shown in FIG. 13 is displayed on the liquid crystal display 34.

In Step S43, the category identification information selection accept unit 78 determines, as the user operates the numeral key of the operation key 36, whether or not the category identification information that is selected by pressing the numeral key associated with the category identification information for the short period of time exists.

That is, when the user presses a numeral key 1 associated with the category identification information 1 for a short period of time, the category identification information selected while the numeral key associated with the category identification information is pressed for a short time is the category identification information 1. It is hence determined that the category identification information selected by pressing the numeral key associated with the category identification information for the short period of time exists.

In Step S43, when it is determined that the category identification information selected by pressing the numeral key associated with the category identification information for the short period of time does not exists, the category identification information selection accept unit 78 stands by until it is determined that the category identification information selected by pressing the numeral key associated with the category identification information for the short period of time the category identification information exists.

According to this configuration, until the user presses the numeral key associated with the category identification information for the short period of time, a screen displayed for the first time as the category identification information display screen (for example, the category identification information display screen related to the category identification information 1) is displayed on the liquid crystal display 34.

On the other hand, in Step S43 when it is determined that there exists the category identification information that is selected by pressing the numeral key associated with the category identification information for the short period of time, the category identification information selection accept unit 78 accepts in Step S44 the selection of the category identification information selected while the numeral key associated with the category identification information is pressed for the short period of time.

To be more specific, in the case of the example of FIG. 13, the category identification information selection accept unit 78 accepts the selection of one category identification information among the category identification informations 1 to 8 when one of numeral keys 1 to 8 associated with the category identification information 1 to 8 is pressed for the short period of time.

The category identification information selection accept unit 78 supplies the category identification information whose selection is accepted to the display control unit 76 as the numeral key associated with the category identification information is pressed for the short period of time.

Thereafter, the process is shifted to Step S45. On the basis of the main menu, the plurality of sub menus, and the sub menu management file associated with the category identification information whose selection has been accepted, the category identification information display screen related to the category identification information whose selection has been accepted is displayed on the liquid crystal display 34.

With this configuration, when the user only presses the numeral key associated with the category identification information for the short period of time, it is possible to select one of the category identification information and display the category identification information display screen related to the selected category identification information.

Therefore, as compared with a case where the user operates the arrow key in the operation key, for example, it is possible to display the category identification information display screen related to the selected category identification information in a short period of time, and at the same time, in a simplified manner. As a result, in a case where the plurality of functions that are mounted to the information processing device are utilized, the operability can be further improved.

In Step S46, the category identification information selection accept unit 78 determines whether or not there is another category identification information selected while the numeral key associated with the category identification information is pressed for the short period of time as the user operates the numeral key of the operation key 36.

In Step S46, when it is determined that there is another category identification information selected while the numeral key associated with the category identification information is pressed for the short period of time, the process is returned to Step S44, and thereafter, the process in Step S44 and subsequent step is repeatedly performed.

With this configuration, as only the user operates the numeral key in the operation key 36, it is possible to repeatedly display the category identification information display screen related to each of the category identification information as many times as needed.

Therefore, as compared with the case where the user operates the arrow key in the operation key 36, for example, it is possible to display the category identification information display screen related to the selected category identification information in a short period of time and at the same time in a simplified manner. As a result, in a case where the plurality of functions that are mounted to the information processing device are utilized, the operability can be further improved.

In Step S46, when it is determined that there is no another category identification information selected while the numeral key associated with the category identification information is pressed for the short period of time, the sub menu selection reception unit 79 determines in Step S47 whether or not there is a sub menu selected while the numeral key associated with the sub menu is pressed for a long period of time.

That is, in the case of the example of FIG. 13, when the user presses the numeral key 4 associated with the sub menu “Draft” (sub menu 4), the sub menu selected while the numeral key associated with the sub menu is pressed for a long period of time is the sub menu “Draft” (sub menu 4), and it is determined that there is a sub menu selected while the numeral key associated with the sub menu is pressed for a short period of time.

In Step S47, when it is determined that there is a sub menu selected while the numeral key associated with the sub menu is pressed for a long period of time, the sub menu selection reception unit 79 accepts in Step S48 the selection of the sub menu selected while the numeral key associated with the sub menu is pressed for a long period of time.

More specifically, in the case of the example of FIG. 13, the category identification information selection accept unit 78 accepts the selection of one sub menu among the plurality of sub menus as one of the numeral keys associated with the sub menus (“Mail box”, “Composition”, “New mail reception”, “Draft”, “Template”, and “Unsent box” of the sub menu 1 to 6, and the like) is pressed for a short period of time.

Thereafter, the process is shifted to Step S49 and the process in Step S49 and subsequent steps is executed.

With this configuration, when the user only presses the numeral key associated with the sub menu for a long period of time, one of the sub menus can be selected to control the execution of the function previously associated with the selected sub menu or the lower hierarchy rank sub menu display screen that is at a lower hierarchy rank of the sub menu can be displayed.

Therefore, as compared with the case where the user operates the arrow key in the operation key 36, for example, it is possible to perform the operation in a short period of time and at the same time in a simplified manner. As a result, in a case where the plurality of functions that are mounted to the information processing device are utilized, the operability can be further improved.

In Step S52, the lower hierarchy rank sub menu selection reception unit 80 determines whether or not there is a lower hierarchy rank sub menu selected while the numeral key associated with the lower hierarchy rank sub menu is pressed for a long period of time.

That is, in the case of the example of FIG. 19, when the user presses the numeral key 1 associated with the lower hierarchy rank sub menu of “Ring volume” (the lower hierarchy rank sub menu 1) for a long period of time, the lower hierarchy rank sub menu selected while the numeral key associated with the lower hierarchy rank sub menu is the lower hierarchy rank sub menu of “Ring volume” (the lower hierarchy rank sub menu 1). It is hence determined that there is a lower hierarchy rank sub menu selected while the numeral key associated with the lower hierarchy rank sub menu is pressed for a long period of time.

In Step S52, when it is determined that there is no lower hierarchy rank sub menu selected while the numeral key associated with the lower hierarchy rank sub menu is pressed for a long period of time, the lower hierarchy rank sub menu selection reception unit 80 stands by until it is determined that there is a lower hierarchy rank sub menu selected while the numeral key associated with the lower hierarchy rank sub menu is pressed for a long period of time.

With this configuration, until the numeral key associated with the lower hierarchy rank sub menu is pressed for a long period of time by the user, the lower hierarchy rank sub menu display screen can be displayed on displayed on the liquid crystal display 34.

In Step S52, when it is determined that there is a lower hierarchy rank sub menu selected while the numeral key associated with the lower hierarchy rank sub menu is pressed for a long period of time, the lower hierarchy rank sub menu selection reception unit 80 accepts in Step S53 the selection of the lower hierarchy rank sub menu selected while the numeral key associated with the lower hierarchy rank sub menu is pressed for a long period of time.

To be more specific, in the case of the example of FIG. 19, the lower hierarchy rank sub menu selection reception unit 80 accepts one of the selections of the lower hierarchy rank sub menus (“Ring volume level 3”, “□ button confirmation-sound”, “Vibrating pattern 1” of the lower hierarchy rank sub menus 1 to 3, and the like) selected while one of the numeral keys 1 to 3 associated with the lower hierarchy rank sub menus is pressed a long period of time.

Thereafter, the process is shifted to Step S54, and the execution of the function previously associated with the lower hierarchy rank sub menu whose selection has been accepted.

According to the embodiments of the present invention, the category identification information, the user is asked to select the sub menu, and the lower hierarchy rank sub menu by adopting the short press or the long press and the numeral keys in combination, and thus, it is possible to perform the operation in the category identification information display control process in a short period of time, and at the same time, in a simplified manner.

Therefore, in a case where the plurality of functions that are mounted to the information, processing device are utilized, the operability can be further improved.

It should be noted that according to the embodiments of the present invention, the user is asked to select the category identification information by pressing the numeral key associated with the category identification information for a short period of time, and asked to select the sub menu or the lower hierarchy rank sub menu by pressing the numeral key associated with the sub menu or the lower hierarchy rank sub menu for a long period of time.

However, this method is not limited to the above-mentioned case, and the short press and the long press may be set oppositely for the selection in accordance with a preference of the user.

Furthermore, according to the embodiments of the present invention, the application program, the setting screen, and the like are specifically described as the functions previously associated with the sub menus, etc., but the present invention is not limited to the above-mentioned case.

It should be noted that the present invention can also be applied to a PDA (Personal Digital Assistant), a personal computer, and other information processing devices other than the mobile phone.

It should be noted that the series of the processes described according to the embodiments of the present invention may be executed by a software but may also be executed by a hardware.

Moreover, according to the embodiments of the present invention, the steps of the flowcharts show an example of the processes executed in time series in the stated order. However, the present invention also includes the processes executed in parallel or executed individually although not necessarily executed in time series.

What is claimed is:

1. An information processing device, comprising:
a memory unit configured to store a main menu information and a plurality of sub menu information related to the main menu information while being associated with category identification information indicating a category of the main menu information;
a display unit configured to display the main menu information and the plurality of the sub menu information which are stored while being associated with the category identification information by the memory unit, for each category identification information;
a category identification information reception unit configured to accept a selection of one of the category identification information among plural pieces of the category identification information;
a sub menu reception unit configured to accept a selection of one of the sub menu among the plurality of the sub menu information associated with the category identification information whose selection is accepted; and
a control unit configured to control an execution of a function related to the sub menu whose selection is accepted by the sub menu reception unit.

2. The information processing device according to claim 1, wherein the memory unit is configured to store the sub menu information while being classified in hierarchy ranks to be associated with a plurality of lower hierarchy rank sub menu information which belong to a lower hierarchy rank, and the display unit is configured to display a plurality of the lower hierarchy rank sub menu information associated with the sub menu information whose selection is accepted by the sub menu reception mean.

3. The information processing device according to claim 2, further comprising a lower hierarchy rank sub menu reception unit configured to accept a selection of one of the lower hierarchy rank sub menu information, wherein the control unit is configured to control an execution of a function related to the lower hierarchy rank sub menu whose selection is selected by the lower hierarchy rank sub menu reception unit.

4. The information processing device according to claim 1, wherein the category identification information reception unit determines whether or not the selection of one category identification information is accepted in a predetermined period of time among the plural pieces of the category identification information and accepts the selection of the category identification information in which it is determined that the selection is accepted in the predetermined period of time.

5. The information processing device according to claim 1, wherein the sub menu reception unit determines whether or not the selection of one sub menu is accepted in a predetermined period of time among the plurality of the sub menu information associated with the category identification information whose selection is accepted by the category identification information reception unit and accepts the selection of the sub menu in which it is determined that the selection is accepted in the predetermined period of time.

6. The information processing device according to claim 1, further comprising a new sub menu reception unit configured to accept a selection of a new sub menu stored in the memory unit while being associated with the main menu information and the category identification information, wherein the memory unit stores the new sub menu while being associated with the main menu information and menu identification information.

7. The information processing device according to claim 6, further comprising a prescribed sub menu determination unit configured to determine whether or not the new sub menu whose selection is accepted by the new sub menu reception unit is a prescribed sub menu previously determined; a type recognition unit configured to recognize a type of the new sub menu when it is determined, by the prescribed sub menu determination unit, that the new sub menu whose selection is accepted is the prescribed sub menu; and a category identification information setting unit configured to set category identification information for storing the new sub menu while being associated with category identification information on the basis of a type recognition result by the type recognition unit,
wherein the memory unit stores the new sub menu while being associated with the category identification information set by the category identification information setting unit.

8. The information processing device according to claim 6, further comprising a registration candidate category identification information reception unit configured to accept a selection of the category identification information that is stored while being associated with the new sub menu among the plural pieces of the category identification information when it is determined, by the prescribed sub menu determination unit, that the new sub menu whose selection is accepted is not the prescribed sub menu, wherein the memory unit stores the new sub menu while being associated with the category identification information whose selection is accepted by the registration candidate category identification information reception unit.

9. An information processing device, comprising:
a memory unit configured to store category identification information while being associated with a plurality of sub menu information related to the category identification information;
a display unit configured to display plural pieces of the category identification information in a predetermined direction and displaying a plurality of the sub menu information stored while being associated with one category identification information among the plural pieces of the category identification information in a same direction as the predetermined direction;
a category identification information reception unit configured to accept a selection of one category identification information among the plural pieces of the category identification information;
a sub menu reception unit configured to accept a selection of one sub menu among the plurality of sub menu information while being associated with one category identification information whose selection is accepted by the category identification information reception unit; and
a control unit configured to control an execution of a function related to the sub menu whose selection is accepted by the sub menu reception unit.

10. The information processing device according to claim 9, wherein the memory unit is configured to store the sub menu information while being classified in hierarchy ranks to be associated with a plurality of lower hierarchy rank sub menu information which belong to a lower hierarchy rank, and the display unit is configured to display a plurality of the lower hierarchy rank sub menu information associated with the sub menu information whose selection is accepted by the sub menu reception mean.

11. The information processing device according to claim 10, further comprising a lower hierarchy rank sub menu reception unit configured to accept a selection of one of the lower hierarchy rank sub menu information, wherein the control unit is configured to control an execution of a function related to the lower hierarchy rank sub menu whose selection is selected by the lower hierarchy rank sub menu reception unit.

12. The information processing device according to claim 10, wherein the category identification information reception unit determines whether or not the selection of one category identification information is accepted in a predetermined period of time among the plural pieces of the category identification information and accepts the selection of the category identification information in which it is determined that the selection is accepted in the predetermined period of time.

13. The information processing device according to claim 10, wherein the sub menu reception unit determines whether or not the selection of one sub menu is accepted in a predetermined period of time among the plurality of the sub menu information associated with the category identification information whose selection is accepted by the category identification information reception unit and accepts the selection of the sub menu in which it is determined that the selection is accepted in the predetermined period of time.

14. The information processing device according to claim 10, further comprising a new sub menu reception unit configured to accept a selection of a new sub menu stored in the memory unit while being associated with the main menu information and the category identification information, wherein the memory unit stores the new sub menu while being associated with the main menu information and menu identification information.

15. The information processing device according to claim 14, further comprising a prescribed sub menu determination unit configured to determine whether or not the new sub menu whose selection is accepted by the new sub menu reception unit is a prescribed sub menu previously determined; a type recognition unit configured to recognize a type of the new sub menu when it is determined, by the prescribed sub menu determination unit, that the new sub menu whose selection is accepted is the prescribed sub menu; and a category identification information setting unit configured to set category identification information for storing the new sub menu while being associated with category identification information on the basis of a type recognition result by the type recognition unit,
wherein the memory unit stores the new sub menu while being associated with the category identification information set by the category identification information setting unit.

16. The information processing device according to claim 14, further comprising a registration candidate category identification information reception unit configured to accept a selection of the category identification information that is stored while being associated with the new sub menu among the plural pieces of the category identification information when it is determined, by the prescribed sub menu determination unit, that the new sub menu whose selection is accepted is not the prescribed sub menu, wherein the memory unit stores the new sub menu while being associated with the category identification information whose selection is accepted by the registration candidate category identification information reception unit.
